(19) United States
(12) Patent Application Publication
(10) Pub. No.: US 2025/0015985 A1
(43) Pub. Date: Jan. 9, 2025

(54) APPARATUSES, COMPUTER-IMPLEMENTED METHODS, AND COMPUTER PROGRAM PRODUCTS FOR IMPROVED DATA LOSS PREVENTION USING PARTIAL ENCRYPTION

(71) Applicant: HONEYWELL INTERNATIONAL INC., CHARLOTTE, NC (US)

(72) Inventor: Kevin Joseph Larson, Scottsdale, AZ (US)

(21) Appl. No.: 18/348,567

(22) Filed: Jul. 7, 2023

(51) Int. Cl. H04L 9/08; H04L 9/14; H04L 9/32

(52) U.S. Cl. CPC H04L 9/0869; H04L 9/14; H04L 9/3231

(57) ABSTRACT

Embodiments of the disclosure provide for partial encryption of data to improve data loss prevention. Some embodiments receive a request to transfer a file from a computing device to a file storage device, identify a random subset of bytes in the file, and replace the random subset of bytes with random data to generate a randomly modified file. Some embodiments generate a data object indicative of an original value of each byte of the random subset of bytes, encrypt the data object with a first key, and generate a legend data object comprising a location array defining a location of each original value. Some embodiments, encrypt the first key with a second key to generate an encrypted first key, store the encrypted first key and the encrypted data object in the legend data object, and provide the randomly modified file and the legend data object to the file storage device.

### TECHNOLOGICAL FIELD

Embodiments of the present disclosure are generally directed to preventing data loss by partially encrypting data.

### BACKGROUND

Existing approaches to preventing data loss typically rely on voluntary compliancy of human operators with data security protocols. For example, data loss often results from improper or otherwise unapproved movement of files (e.g., by transfer from one device to another end device, intermediary storage medium such as a USB thumb drive, and/or the like), whether by trusted or untrusted entities, where the files remain usable after such movement.

Applicant has discovered various technical problems associated with conventional data loss prevention techniques. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for improved data loss prevention using partial encryption. Other implementations for data loss prevention using partial encryption will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for improved data loss prevention is provided. The computer-implemented method is executable utilizing any of a myriad of computing device(s) and/or combinations of hardware, software, firmware. In some example embodiments an example computer-implemented method includes receiving a request to transfer a file from a computing device to a file storage device. The example computer-implemented method further includes determining a random subset of bytes in the file. The example computer-implemented method further includes replacing the random subset of bytes in the file with random data to generate a randomly modified file. The example computer-implemented method further includes generating a data object indicative of an original value of each byte of the random subset of bytes in the file. The example computer-implemented method further includes encrypting the data object with a first key to generate an encrypted data object. The example computer-implemented method further includes generating a legend data object comprising a location array defining a location of the original value of each byte of the random subset of bytes in the file. The example computer-implemented method further includes encrypting the first key with a second key to generate an encrypted first key. The example computer-implemented method further includes storing the encrypted first key and the encrypted data object in the legend data object. The example computer-implemented method further includes providing the randomly modified file and the legend data object to the file storage device.

In some example embodiments, the computing device is a first computing device and the randomly modified file is configured to be decryptable, from the file storage device, at a second computing device during a checkout procedure based at least in part on the legend data object. The example computer-implemented method may further include performing a decryption operation comprising (i) decrypting the first key using the second key, (ii) decrypting the encrypted data object using the first key to obtain the random subset of bytes of the file, (iii) obtaining the location array from the legend data object, and (iv) restoring the file by replacing the random data of the randomly modified file with the random subset of bytes of the file based on the location array. In some example embodiments, the decryption operation is performed by the second computing device as a subprocess of the file checkout procedure. The example computer-implemented method may further include providing, at the second computing device, user access to the second key based on a biometric verification operation.

In some example embodiments, the computer-implemented method further includes determining the random subset of bytes in the file based on a file percentage parameter. The example computer-implemented method may further include determining the file percentage parameter based on a file transfer policy. The example computer-implemented method may further include determining the file percentage parameter based on a pseudorandom number generator. The example computer-implemented method may further include determining the file percentage parameter based on a user input. The example computer-implemented method may further include applying a file transfer policy to the user input to generate the file percentage parameter. The example computer-implemented method may further include, in response to the request to transfer the file, providing a graphical user interface to the computing device, where the graphical user interface allows a user to provide the user input.

In some example embodiments, the example computer-implemented method further includes encrypting the legend data object using the second key prior to providing the legend data object to the file storage device. In some example embodiments, the example computer-implemented method further includes encrypting the location array using the first key. In some example embodiments, the example computer-implemented method further includes determining the random subset of bytes in the file based on a random integer walk. The example computer-implemented method may further include initializing the random integer walk at a random location in the file, wherein the random location is determined based on at least one of a user input, a file transfer policy, or a pseudorandom number generator.

In accordance with another aspect of the present disclosure, a computing apparatus for improved data loss prevention is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for improved data loss prevention is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example data flow in accordance with at least some example embodiments of the present disclosure.

FIG. 4 illustrates an example data architecture in accordance with at least some example embodiments of the present disclosure.

FIG. 5 illustrates a diagram of an example workflow for data loss prevention using partial encryption in accordance with at least some example embodiments of the present disclosure.

FIG. 6 illustrates a flowchart depicting operations of an example process for data loss prevention using partial encryption in accordance with at least some example embodiments of the present disclosure.

FIG. 7 illustrates a flowchart depicting operations of an example process for decryption accordance with at least some example embodiments of the present disclosure.

FIG. 8 shows an example graphical user interface (GUI) that includes user input fields for partial encryption and decryption, where at least some of the various named aspects of the GUI may be generated in accordance with the previously described and depicted figures.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Preventing loss of control of proper access and/or accessibility of data (“data loss”) often involves several aspects of physical security and data security. Data loss prevention systems may include a voluntary checkout procedure for removing or copying files from a data system to a secondary device, and/or otherwise moving data from an environment in which such data is stored. As a result, data storage locations are exposed to a risk of a malicious user removing or copying files without performing the voluntary checkout procedure. In addition, some data loss prevention mechanisms may rely on full encryption of files on a system in an attempt to avoid issues with unauthorized access of such files outside of an intended environment. However, the full encryption of large files can be time-consuming, thereby reducing throughput of activities involving such data transfer, reducing human capital efficiencies associated with data movement, and increasing computing resource expenditure to complete a given transfer.

Embodiments of the present disclosure provide a myriad of technical advantages in the technical field of data loss prevention. Some embodiments provide and utilize partial encryption processes and techniques for data checkout and transfer procedures, for example of particular files. Such processes and techniques may increase security and traceability of files that are transferred, removed, or otherwise to be removed while overcoming computational efficiency challenges of conventional approaches. Some embodiments receive a request to transfer a file to a file storage device and, before transferring the file, replace a random subset of bytes in the file with random data to generate a randomly modified file. Some embodiments generate a data object that includes the original values of the replaced bytes. Some embodiments generate a location array indicative of the location of the replaced bytes in the file. In some embodiments, the data object and the location array may be used to decrypt a randomly modified file by restoring the randomly modified file to an original composition. Some embodiments, encrypt the data object using a first key. Some embodiments generate a legend data object including the location array, the encrypted data object, and the first key, where the first key may be encrypted using a second key. Some embodiments provide the randomly modified file, the encrypted data object, and the legend data object to the file storage device.

### Definitions

“File” refers to any data construct for recording computer-readable data. In some contexts, a file includes one or more one- or multi-dimensional arrays of bytes. A file may be any container for data, including folders, databases, and other data constructs that contain multiple files.

“File storage device” refers to any device that stores computer-readable data. For example, a file storage device may be a physical device carried by a user, a partition of a remote storage device, and/or the like, that stores files. Non-limiting examples, of the file storage device include hard disk drives, virtual storage environments (e.g., cloud storage and/or the like), solid-state drives, universal serial bus (USB) drives, memory cards, floppy disks, secure digital (SD) cards, tape drives, random access memory (RAM), read-only memory (ROM), compact disc (CD)-ROM, digital versatile disk (DVD), other optical media storage, magnetic storage, and/or the like.

“Pseudorandom number generator” refers to any technique, algorithm, model, and/or the like that generates numbers within a predetermined range such that the output numbers lack any pattern or sequence that enables prediction with accuracy greater than random selection. A pseudorandom number generator may generate output based on one or more seed values or other data, such as measurements of entropy.

“Original value” refers to an original byte value of a file prior the file being modified according to one or more embodiments of the partial encryption techniques described herein. For example, an original value may be a byte value prior to replacement of the original byte value with a random byte value (e.g., as performed via partial encryption techniques) or a byte value that replaces a random byte value (e.g., reversal of partial encryption as performed via decryption techniques).

“Notification” refers to any electronic message that is transmissible and/or renderable to a computing device for display and/or processing. Non-limiting examples of a notification include an electronic mail (e-mail) message, SMS text messages, instant messages, telephone calls, push alerts, and/or the like. In some embodiments, the notification includes or indicates information associated with automated management of software modifications. For example, in some contexts, the notification indicates and/or includes information associated with a randomly modified file or original file from which the randomly modified file was generated. In another example, in some contexts, the notification indicates and/or includes information associated with a request to transfer a file from a computing device to a file storage device. In another example, in some contexts, the notification indicates and/or includes information associated with a file transfer policy. In another example, in some contexts, the notification includes a transfer report that indicates a record of transfer of a file from a computing device, or system, to other computing devices, other systems, or file storage devices.

### Example Systems and Apparatuses of the Disclosure

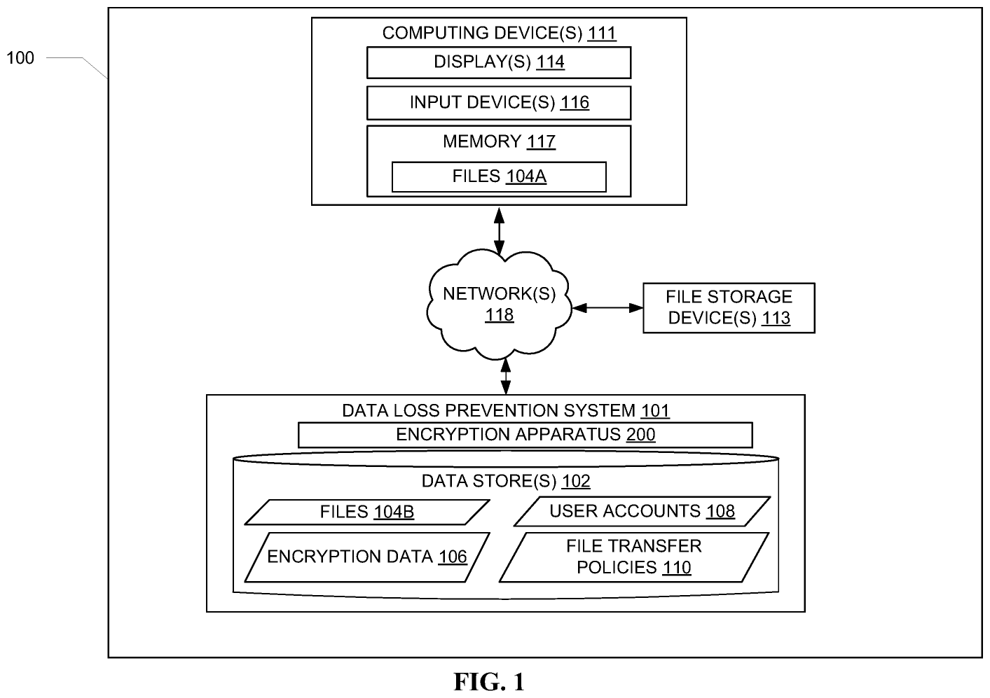

FIG. 1 illustrates a block diagram of a system that may be specially configured within which embodiments of the present disclosure may operate. Specifically, FIG. 1 depicts an example system 100. As illustrated, the system 100 includes a data loss prevention system 101, one or more computing devices 111, and one or more file storage devices 113. In some embodiments, the computing device 111 is configured to provide file transfer requests to the data loss prevention system 101. For example, the data loss prevention system 101 may receive a request, from a computing device 111, to transfer a file 104 from the computing device 111 or data loss prevention system 101 to a file storage device 113. In some embodiments, the data loss prevention system 101 is configured to receive a request to transfer a file from a computing device 111 to a file storage device 113 and, before transferring the file, perform various operations to prevent data loss, such as an instance in which a user transfers a file without following a checkout procedure. In some embodiments, the various operations include determining a random subset of bytes in the file, replacing the random subset of bytes in the file with random data to generate a randomly modified file, generating a data object indicative of an original value of each byte of the random subset of bytes in the file, encrypting the data object with a first key to generate an encrypted data object, generating a legend data object including a location array defining a location of the original value of each byte of the random subset of bytes in the file, encrypting the first key with a second key to generate an encrypted first key, storing the encrypted first key and the encrypted data object in the legend data object, providing the randomly modified file and the legend data object to the file storage device 113, and potentially other operations.

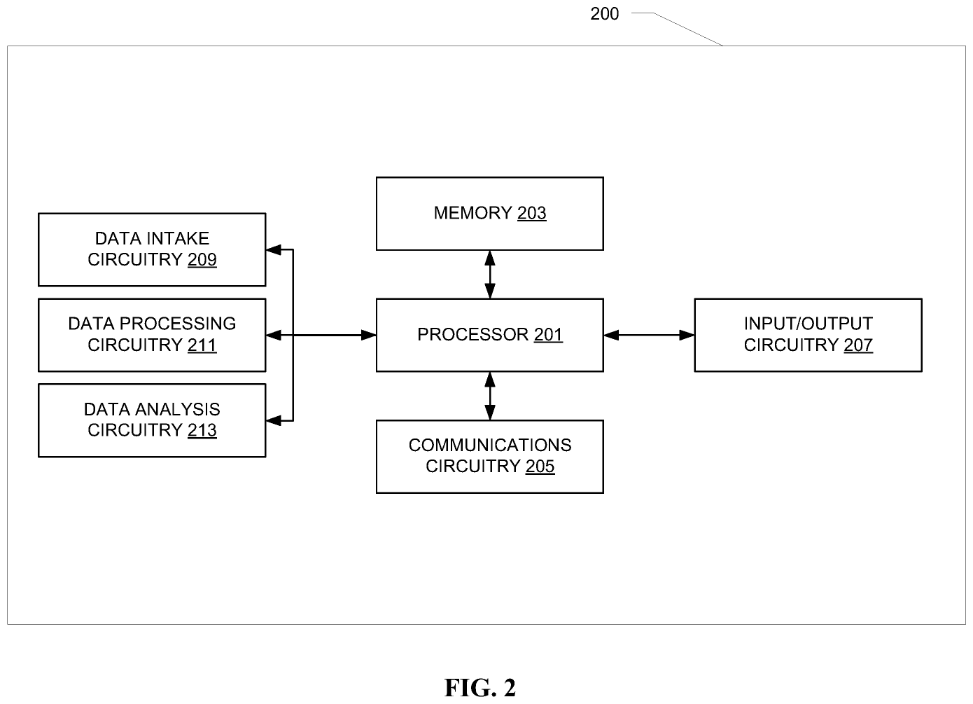

In some embodiments, the data loss prevention system 101 is embodied as, or includes one or more of, an encryption apparatus 200 (e.g., as further illustrated in FIG. 2 and described herein). Various applications and/or other functionality may be executed in the data loss prevention system 101 and/or encryption apparatus 200 according to various embodiments. In some embodiments, the encryption apparatus 200 is embodied as a software program installed on a computing device 111. For example, functions and operations of the encryption apparatus 200 may be invoked and executed at the computing device 111 in response to the computing device 111 receiving a user input requesting transfer of a file 104A from memory 117 of the computing device 111 (or transfer of a file 104B from a data store 102 of the data loss prevention system 101) to a file storage device 113.

In some embodiments, the data loss prevention system 101 includes, but is not limited to, the one or more encryption apparatuses 200 and one or more data stores 102. The various data in the data store 102 may be accessible to one or more of the data loss prevention system 101, the encryption apparatus 200, and the computing device 111. For example, the computing device 111 may access files 104B stored at the data store 102. The encryption apparatus 200 may receive requests from the computing device 111 to transfer (e.g., move or copy) a file 104B from the data store 102 to a file storage device 113. The data store 102 may be representative of a plurality of data stores 102 as can be appreciated. The data stored in the data store 102, for example, is associated with the operation of the various applications, apparatuses, and/or functional entities described herein. The data stored in the data store 102 may include, for example, files 104B, encryption data 106, user accounts 108, and file transfer policies 110. In some embodiments, the memory 117 of the computing device 111 includes data from the data store 102. For example, the memory 117 may include encryption data 106, a user account 108, one or more file transfer policies 110, and/or the like.

In some embodiments, the files 104A, 104B include containers for data. For example, a file 104A or 104B may include a software patch file. In another example, a file 104A or 104B may include a media file, such as a video file, audio file, image file, and/or the like. In another example, a file 104A or 104B may include a spreadsheet file. In still another example, the file 104A or 104B may include a three-dimensional (3D) file, such as a stereolithography file, object file, or standard for the exchange of product data (STEP) file. In some embodiments, a file 104A or 104B includes a folder including one or more files or a database including one or more folders or files. The file 104A or file 104B may be in an original format such that the file 104A or 104B is computer readable to access the data contained thereby.

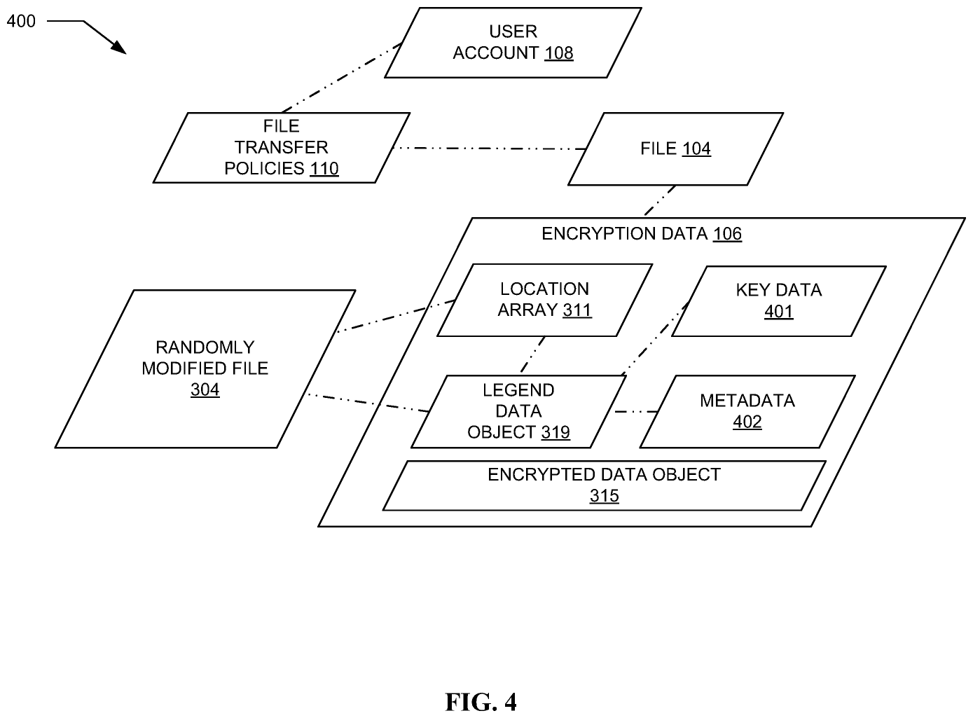

In some embodiments, the encryption data 106 includes data related to various processes and operations described herein for improving data loss prevention using partial encryption. In some embodiments, the encryption data 106, or elements thereof, are stored only temporarily for a period sufficient to enable use of the data in processes and operations described herein, after which the temporarily stored data may be deleted from the data store 102 (or memory 117). In some embodiments, the encryption data 106 includes a random subset of bytes from a file 104A or file 104B (e.g., a set of bytes to be replaced with random data in the file 104A or file 104B). In some embodiments, the encryption data 106 includes a data object including data that indicates an original value of each byte of the random subset of bytes. In some embodiments, the encryption data 106 includes a location array including data that defines a location of each byte of the random subset of bytes in the corresponding file 104A or file 104B. In some embodiments, the encryption data 106 includes one or more first keys for encrypting/decrypting other encryption data 106, such as a data object including original byte values and/or a location array. In one example, the first key may be a cryptographic key generated using a symmetric key algorithm, such as an Advanced Encryption Standard (AES) key. In some embodiments, the encryption data 106 includes one or more second keys for encrypting/decrypting the first key. In some embodiments, the second key may be a public key or a private key of a key pair generated using an asymmetric key algorithm, such as a Rivest-Shamir-Adleman (RSA) key pair. In some embodiments, a computing device 111 that uses the file storage device 113 to decrypt a randomly modified file 304 to restore an original file 104 may be provisioned with a private key of a key pair. For example, the apparatus 200 may generate an RSA key pair including a public key and a private key, store the public key (e.g., potentially in association with an identifier for a computing device 111 and/or user account 108), and provide the private key to the computing device 111. Further exemplary aspects of the encryption data 106 are shown in the data architecture 400 depicted in FIG. 4 and described herein.

In some embodiments, the user account 108 include credentials for a user, such as a name, username, contact information (e.g., email address, phone number, and/or the like), biometric templates, device data (e.g., Internet Protocol (IP) address, Media Access Control (MAC) address, International Mobile Equipment Identity (IMEI) number, and/or the like), physical location, employment status, clearance or other permission level, and/or the like. In some embodiments, the user account 108 includes associations between the user account 108 and one or more file transfer policies 110. For example, the user account 108 may include an association with a file transfer policy 110 that defines a file percentage parameter or a range of file percentage values. In some embodiments, the user account 108 includes an indication of a computing device 111 with which the corresponding user is associated. In some embodiments, the user account 108 includes associations between the user account 108 and encryption data 106, such as encrypted data objects including original values of bytes replaced in a file 104A, 104B, location arrays, legend data objects, encryption keys, and/or the like. In some embodiments, the user account 108 includes associations between the user account 108 and one or more files 104A, 104B and/or randomly modified files generated based on partially encrypting the file 104A, 104B. In some embodiments, the user account 108 includes historical data associated with operations performed by the data loss prevention system 101 on behalf of or in association with the user account 108. For example, the user account 108 includes historical file transfer requests, historical decryption requests, identifiers for historical file storage devices 113 associated with the historical requests, metadata associated with requests (e.g., timestamps, filenames, physical locations, network locations), and/or the like.

In some embodiments, the computing device 111 and/or file storage device 113 is/are communicable with the data loss prevention system 101. In some embodiments, the data loss prevention system 101, the encryption apparatus 200, the computing device 111, and/or the file storage device 113 are communicable over one or more communications network(s), for example the communications network(s) 118.

It should be appreciated that the communications network 118 in some embodiments is embodied in any of a myriad of network configurations. In some embodiments, the communications network 118 embodies a public network (e.g., the Internet). In some embodiments, the communications network 118 embodies a private network (e.g., an internal, localized, and/or closed-off network between particular devices). In some other embodiments, the communications network 118 embodies a hybrid network (e.g., a network enabling internal communications between particular connected devices and external communications with other devices). The communications network 118 in some embodiments may include one or more base station(s), relay(s), router(s), switch(es), cell tower(s), communications cable(s) and/or associated routing station(s), and/or the like. In some embodiments, the communications network 118 includes one or more user-controlled computing device(s) (e.g., a user owner router and/or modem) and/or one or more external utility devices (e.g., Internet service provider communication tower(s) and/or other device(s)).

Each of the components of the system communicatively coupled to transmit data to and/or receive data from one another over the same or different wireless or wired networks embodying the communications network 118. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 118, the various embodiments are not limited to this particular architecture. In other embodiments, one or more computing entities share one or more components, hardware, and/or the like, or otherwise are embodied by a single computing device such that connection(s) between the computing entities are over the communications network 118 are altered and/or rendered unnecessary.

The computing device 111 includes one or more computing device(s) accessible to an end user. In some embodiments, the computing device 111 includes a personal computer, laptop, smartphone, tablet, Internet-of-Things enabled device, smart home device, virtual assistant, alarm system, workstation, work portal, and/or the like. The computing device 111 may include one or more displays 114, one or more visual indicator(s), one or more audio indicator(s) and/or the like that enables output to a user associated with the computing device 111. For example, in some embodiments, the data loss prevention system 101 provides a graphical user interface (GUI) for rendering on the display 114. In another example, the data loss prevention system 101 may provide a notification to the computing device 111, where the notification includes or embodies a file transfer report or indicates successful transfer of a file having been partially encrypted (e.g., or, alternatively, refusal to transfer a file, such as in response to a failure to authenticate an encryption key, a failed biometric authentication operation, or a failed multi-factor authentication operation).

In some embodiments, the computing device 111 includes one or more input devices 116 for receiving user inputs, such as requests to transfer a file 104A, 104B or requests to decrypt a randomly modified file to restore a file 104A, 104B. In some embodiments, the input device 116 include one or more buttons, cursor devices, touch screens, including three-dimensional- or pressure-based touch screens, camera, finger print scanners, accelerometer, retinal scanner, gyroscope, magnetometer, and/or other input devices. In some embodiments, the computing device 111 is configured to communicate with the file storage device 113. For example, the computing device 111 may provide data to or retrieve data from the file storage device 113 (or request the data loss prevention system 101 to provide or retrieve data to or from the file storage device 113). In some embodiments, the computing device 111 includes memory (e.g., volatile and/or non-volatile memory as described herein) configured to store various data that may be accessible to the computing device 111 and encryption apparatus 200 to perform various operations and functions described herein. In some embodiments, the computing device 111 includes one or more files 104B, and potentially other data, such as one or more randomly modified files and encryption data 106 for decrypting the randomly modified file.

In some embodiments, the file storage device 113 is any device that stores computer-readable data. For example, a file storage device 113 may be a physical device carried by a user, a partition of a remote storage device, and/or the like, that stores files, such as files 104A, 104B or randomly modified files generated by partially encrypting files 104A, 104B as described herein. Non-limiting examples, of the file storage device 113 include other computing devices 111, hard disk drives, virtual storage environments (e.g., cloud storage and/or the like), solid-state drives, universal serial bus (USB) drives, memory cards, floppy disks, secure digital (SD) cards, tape drives, random access memory (RAM), read-only memory (ROM), compact disc (CD)-ROM, digital versatile disk (DVD), other optical media storage, and/or the like. In some embodiments, the computing device 111 or the encryption apparatus 200 transfer and retrieve randomly modified files to and from the file storage device 113, and potentially other data, such as encryption data (e.g., legend data objects, encrypted symmetric keys, encrypted location arrays, and encrypted data objects including original values of replaced bytes from a file 104A, 104B, and/or the like).

In some embodiments, the data loss prevention system 101 receives, from a computing device 111, a request to transfer a file 104A from a computing device to a file storage device 113. In some embodiments, the data loss prevention system 101 determines a random subset of bytes in the file 104A, potentially based on a file percentage parameter as further described herein. In some embodiments, the data loss prevention system 101 generates random data, such as by generating a plurality of random byte values via a pseudorandom value generation technique, algorithm, model, and/or the like. In some embodiments, the data loss prevention system 101 replaces the random subset of bytes in the file 104A with the random data to generate a randomly modified file. In some embodiments, the data loss prevention system 101 generates a data object indicative of an original value of each byte of the random subset of bytes in the file 104A. In some embodiments, the data loss prevention system 101 encrypts the data object with a first key (e.g., a symmetric key, such as an AES key) to generate an encrypted data object. In some embodiments, the data loss prevention system 101 generates a legend data object including a location array that defines a location of the original value of each byte of the random subset of bytes in the file 104A. In some embodiments, the data loss prevention system 101 encrypts the location array using the first key. In some embodiments, the data loss prevention system 101 encrypts the first key with a second key (e.g., a public key of an RSA key pair) to generate an encrypted first key. In some embodiments, the data loss prevention system 101 stores the encrypted first key and the encrypted data object in the legend data object. In some embodiments, the data loss prevention system 101 encrypts the legend data object using the second key. In some embodiments, the data loss prevention system 101 provides the randomly modified file an, and potentially the legend data object, encrypted first key, and encrypted data object, to the file storage device 113.

FIG. 2 illustrates a block diagram of an example apparatus that may be specially configured in accordance with at least some example embodiments of the present disclosure; Specifically, FIG. 2 depicts an example encryption apparatus 200 (“apparatus 200”) specially configured in accordance with at least some example embodiments of the present disclosure. In some embodiments, the data loss prevention system 101 and/or a portion thereof is embodied by one or more system(s), such as the apparatus 200 as depicted and described in FIG. 2. The apparatus 200 includes processor 201, memory 203, communications circuitry 205, input/output circuitry 207, data intake circuitry 209, data processing circuitry 211, and data analysis circuitry 213. In some embodiments, the apparatus 200 is configured, using one or more of the processor 201, memory 203, communications circuitry 205, input/output circuitry 207, data intake circuitry 209, data processing circuitry 211, and/or data analysis circuitry 213, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, modifying, restoring, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure. In some embodiments, the memory 203 is embodied as, or communicates with, a data store 102, and/or one or more file storage devices 113 as shown in FIG. 1 and described herein.

The processor 201 may be embodied in a number of different ways. For example, in some example embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with preventing data loss via partial encryption of files, including determining random subsets of bytes of files, replacing random subsets of bytes in files with random data to generate randomly modified files, generating data objects indicative of original values of random subsets of bytes of files, generating location arrays indicative of locations of random subsets of bytes within files, encrypting and decrypting data objects and/or location arrays using symmetric encryption keys, generating legend data objects including location arrays, data objects, and symmetric encryption keys, encrypting and decrypting legend data objects and/or symmetric encryption keys using asymmetric keys, providing randomly modified files, and potentially other data, to computing devices 111 or file storage devices 113, generating file percentage parameters, applying file transfer policies, and restoring original files (e.g., by decrypting randomly modified files). In some embodiments, the processor 201 includes hardware, software, firmware, and/or a combination thereof, that receives requests to transfer a file, requests to decrypt a randomly modified, and potentially other data. Additionally, or alternatively, in some embodiments, the processor 201 includes hardware, software, firmware, and/or a combination thereof, that automatically initiate partial encryption of files based on file transfer policies. Additionally, or alternatively, in some embodiments, the processor 201 includes hardware, software, firmware, and/or a combination thereof, that perform biometric verification operations and/or multi-factor authentication challenges to provide user access to various data, such as encryption keys, or determine whether to perform operations responsive to a request, such as a request to restore a file by decrypting a randomly modified file.

In some embodiments, the apparatus 200 includes input/output circuitry 207 that provides output to the user and, in some embodiments, to receive an indication of a user input. For example, the input/output circuitry 207 provides output to and receives input from one or more computing devices 111. In another example, the input/output circuitry 207 provides output to one or more file storage devices 113. In one example, the input/output circuitry 207 receives, from a computing device 111, a request to transfer a file to a file storage device 113. In another example, the input/output circuitry 207 receives, from a computing device 111, a request to decrypt a randomly modified file from the computing device 111 or a file storage device 113 in order to restore an original file. In another example, the input/output circuitry 207 receives, from a computing device 111, a user input for configuring a file percentage parameter. In another example, the input/output circuitry 207 receives, from a computing device 111, biometric data for performing a biometric verification operation. In another example, the input/output circuitry 207 receives, from a computing device 111, user inputs for performing a multi-factor authentication challenge, such as user inputs for one or more user credentials. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor (e.g., memory 203, and/or the like). In some embodiments, the input/output circuitry 207 includes or utilizes a user-facing application to provide input/output functionality to a computing device 111 and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 118 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from data stores 102, file storage devices 113, computing devices 111, and/or other external computing devices in communication with the apparatus 200. In some embodiments, the communications circuitry 205 enables generation and transmission of notifications, such as file transfer reports as described herein.

The data intake circuitry 209 includes hardware, software, firmware, and/or a combination thereof, that supports receiving or accessing data associated with operations for data loss prevention, such as files 104, randomly modified files, encryption data, user account data, user inputs, and file transfer policies. For example, in some embodiments, the data intake circuitry 209 includes hardware, software, firmware, and/or a combination thereof, that receives or accesses a file 104 or a randomly modified file. The data intake circuitry 209 may communicate with a data store 102, computing device 111, or file storage device 113 to obtain such data. The data intake circuitry 209 may communicate with computing devices 111 to provide notifications, such as file transfer reports, receive or access encryption keys, receive biometric data and/or other data for completing user verification operations, and/or receive or provide encryption data (e.g., legend data objects, location arrays, encrypted data objects, and/or the like. Additionally, or alternatively, in some embodiments, the data intake circuitry 209 includes hardware, software, firmware, and/or a combination thereof, that requests encryption data, encryption keys, user inputs, biometric data, and potentially other data from the computing device 111, data store 102, or file storage device 113, and which receive the such data in response. Additionally, or alternatively, in some embodiments, the data intake circuitry 209 includes hardware, software, firmware, and/or a combination thereof, that maintains one or more data stores 102 including user accounts 108, files 104, encryption data 106, file transfer policies 110, randomly modified files, and/or the like. In some embodiments, data intake circuitry 209 includes a separate processor, specially configured field programmable gate array (FPGA), and/or a specially programmed application specific integrated circuit (ASIC).

The data processing circuitry 211 includes hardware, software, firmware, and/or a combination thereof, that supports various functionality associated with preventing data loss via partial encryption of files (e.g., and decryption of randomly modified files), including processing requests to transfer a file, determining and processing file transfer policies, processing encryption keys, processing biometric data or other user account or device credentials, processing file percentage parameters, processing a file to partially encrypt the file as described herein, processing a randomly modified file to restore an original file as described herein, generating encryption data, and/or the like. For example, in some embodiments, the data processing circuitry 211 includes hardware, software, firmware, and/or any combination thereof, that determines a random subset of bytes in a file, potentially based on a file percentage parameter. In another example, in some embodiments, the data processing circuitry 211 includes hardware, software, firmware, and/or any combination thereof, that processes a user input for configuring a file percentage parameter. In another example, in some embodiments, the data processing circuitry 211 includes hardware, software, firmware, and/or any combination thereof, that replaces a random subset of bytes of a file with random data to generate a randomly modified file. In another example, in some embodiments, the data processing circuitry 211 includes hardware, software, firmware, and/or any combination thereof, that generates random data (e.g., random byte values), such as via a pseudorandom number generator and/or other random data generation technique, model, algorithm, and/or the like.

Additionally, or alternatively, in some embodiments, the data processing circuitry 211 includes hardware, software, firmware, and/or any combination thereof, that generates a data object indicative of an original value of each byte of a random subset of bytes in a file that were replaced with random data. In some embodiments, the data processing circuitry includes hardware, software, firmware, and/or any combination thereof, that generates a location array that defines a location, within a file, of the original value of each byte of a random subset of bytes from the file. In some embodiments, the data processing circuitry includes hardware, software, firmware, and/or any combination thereof, that generates a legend data object, which may include a location array, a data object indicative of original values of a random subset of bytes, one or more encryption keys, and/or the like. In some embodiments, the data processing circuitry includes hardware, software, firmware, and/or any combination thereof, that encrypt or decrypt, using one or more symmetric encryption keys, location arrays, data objects indicative of original byte values, and/or the like. In some embodiments, the data processing circuitry includes hardware, software, firmware, and/or any combination thereof, that encrypt or decrypt, using one or more asymmetric encryption keys, legend data objects, symmetric encryption keys, and/or the like. In some embodiments, the data processing circuitry 211 includes hardware, software, firmware, and/or any combination thereof, that generates a file transfer report indicative of partial encryption of a file and transfer of the corresponding randomly modified file to a computing device 111 or storage device 113. In some embodiments, the data processing circuitry 211 includes a separate processor, specially configured field programmable gate array (FPGA), and/or a specially programmed application specific integrated circuit (ASIC).

The data analysis circuitry 213 includes hardware, software, firmware, and/or a combination thereof, that supports various functionality associated with preventing data loss via partial encryption of files (e.g., and decryption of randomly modified files), including determining file percentage parameters, identifying byte locations in a file based on file percentage parameters and/or location arrays, performing random integer walks to identify bytes for replacement in an original file, authenticating encryption keys, configuring and applying file transfer policies, performing biometric authentication operations, and performing multi-factor authentication operations. In some embodiments, the data analysis circuitry 213 includes hardware, software, firmware, and/or a combination thereof, that determines a file percentage parameter. For example, the data analysis circuitry 213 may determine a file percentage parameter based on a file transfer policy, a pseudorandom number generator, and/or a user input. Additionally, or alternatively, in some embodiments, the data analysis circuitry 213 includes hardware, software, firmware, and/or a combination thereof, that analyses user inputs to a graphical user interface (GUI) to configure file percentage parameters, identify files for partial encryption, identify randomly modified files for partial decryption, and/or the like. In some embodiments, the data analysis circuitry 213 includes hardware, software, firmware, and/or a combination thereof, that applies a file transfer policy, which may include determining a file type of a file, determining a size of a file, determining a user account 108 and/or computing device 111 associated with a file, determining a physical or network location of a computing device 111, determining one or more aspects of a user account 108 or computing device 111 (e.g., privileges, historical transfer request data, and/or the like), determining whether a computing device 111 has created, downloaded, modified, or saved a file, and/or the like. In some embodiments, the data analysis circuitry 213 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, data intake circuitry 209, data processing circuitry 211, and/or data analysis circuitry 213 are combinable. Additionally, or alternatively, in some embodiments, one or more of the sets of circuitry perform some or all of the functionality described associated with another component. For example, in some embodiments, two or more of the sets of circuitry 201-213 are combined into a single module embodied in hardware, software, firmware, and/or a combination thereof. Similarly, in some embodiments, one or more of the sets of circuitry, for example the data intake circuitry 209, the data processing circuitry 211, and/or the data analysis circuitry 213 is/are combined with the processor 201, such that the processor 201 performs one or more of the operations described above with respect to each of these sets of circuitry 207-213.

### Example Data Flows and Data Architectures of the Disclosure

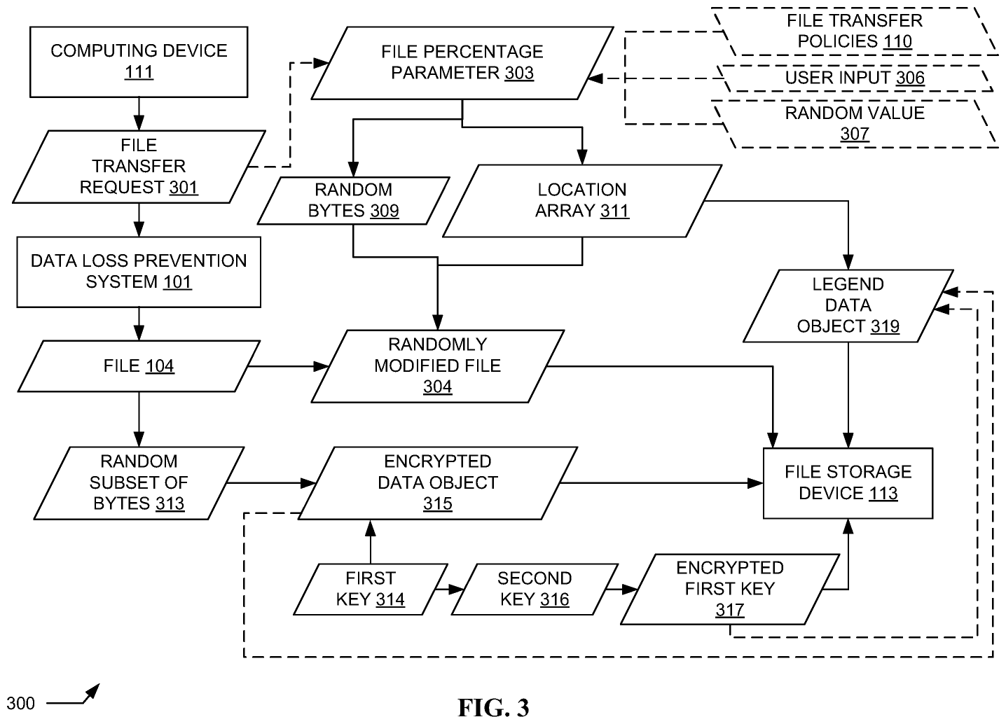

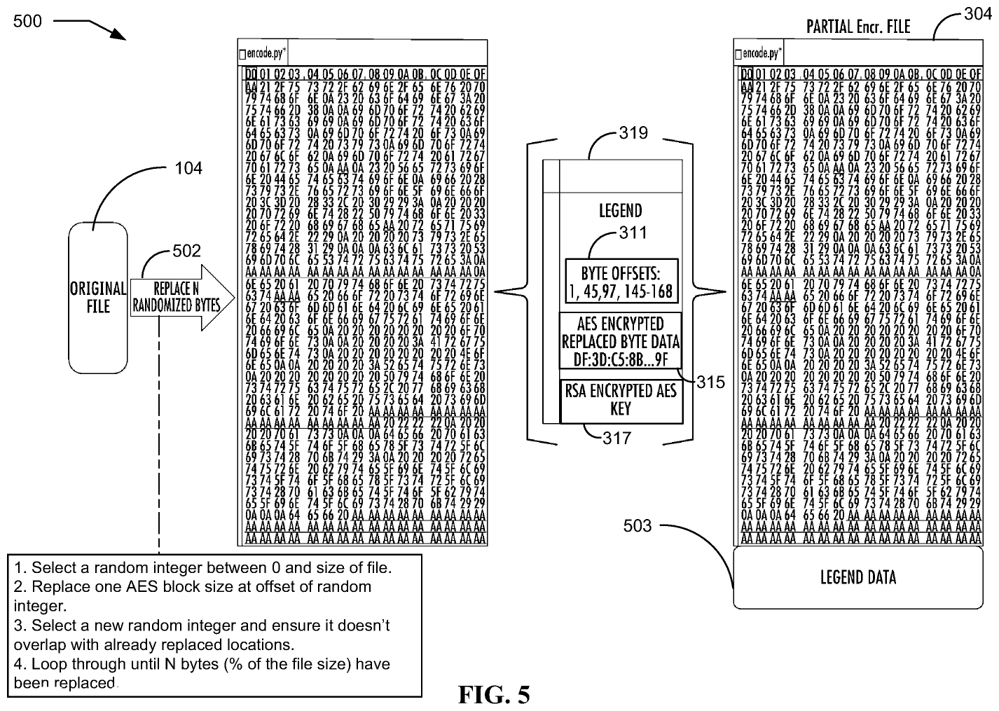

Having described example systems and apparatuses in accordance with embodiments of the present disclosure, example data flows and architectures of data in accordance with the present disclosure will now be discussed. In some embodiments, the systems and/or apparatuses described herein maintain data environment(s) that enable the data flows in accordance with the data architectures described herein. For example, in some embodiments, the systems and/or apparatuses described herein function in accordance with the data flows depicted in and described herein with respect to FIGS. 3 and 5, and the data architectures depicted and/or described with respect to FIG. 4 are performed or maintained via the data loss prevention system 101 embodied by an apparatus 200 (and/or a computing device 111 including software that embodies functionality of the apparatus 200 as described herein).

FIG. 3 illustrates an example data flow 300 in accordance with at least some example embodiments of the present disclosure. Specifically, FIG. 3 depicts a flow of data between the various computing elements depicted and described in FIG. 1.

As illustrated, in some embodiments, the data flow 300 includes the data loss prevention system 101 receiving a file transfer request 301. For example, the data loss prevention system 101 may receive the file transfer request 301 from a computing device, such as a computing device 111. In other embodiments, the file transfer request 301 is a command that is automatically generated by the data loss prevention system 101 based on a file transfer policy. For example, the file transfer request 301 is a command that is automatically generated by the data loss prevention system 101 in response to a computing device 111 creating, downloading, or saving a file 104. In some embodiments, the file transfer request 301 indicates a file 104. In some embodiments, the file 104 is stored in memory 117 of the computing device 111 or in a data store 102 as shown in FIG. 1 and described herein.

In some embodiments, the data flow 300 includes the data loss prevention system 101 determining a file percentage parameter 303. In some embodiments, based on the file percentage parameter 303 the data loss prevention system 101 determines various data for partially encrypting the file 104, including a random subset of bytes 313, random bytes 309 with which the random subset of bytes 313 will be replaced, and a location array 311. In some embodiments, the file percentage parameter 303 defines a percentage of the file 104 that will be encrypted by the data loss prevention system 101 via replacing said percentage of the file 104 with random bytes 309. In some embodiments, the data loss prevention system 101 determines the file percentage parameter 303 based on one or more file transfer policies 110 that may define an explicit value for the file percentage parameter 303, an allowable range of the file percentage parameter 303, and/or the like. For example, the file transfer policy 110 may indicate that, for a software patch file, 40% of the file must be encrypted. In response, the data loss prevention system 101 may determine that 40% of the bytes of the file 104 must be randomly selected and replaced with random bytes 309. In some embodiments, the data loss prevention system 101 determines the file percentage parameter 303 based on a received user input 306, which may indicate a value for the file percentage parameter 303 (e.g., 10%, 20%, 50%, or any suitable value). In some embodiments, the data loss prevention system 101 applies a file transfer policy 110 to the user input 306 to determine that the indicated value for the file percentage parameter 303 meets a predetermined minimum value, is within a predetermined range of values, and/or is at or below a maximum value. In some embodiments, the data loss prevention system 101 determines the file percentage parameter 303 based on a random value 307, which the data loss prevention system 101 may generate using a pseudorandom number generator. In some embodiments, the data loss prevention system configured the pseudorandom number generator based on one or more file transfer policies 110 such that the pseudorandom number generator outputs a value for the file percentage parameter 303 that meets a predetermined minimum value, is within a predetermined range of values, and/or is at or below a maximum value.

In some embodiments, the data loss prevention system 101 generates random bytes 309 based on the file percentage parameter 303. For example, the data loss prevention system 101 may determine a total number of bytes in the file 104 and determine a number N of random bytes 309 to generate by applying the file percentage parameter 303 to the number of bytes in the file 104. In other embodiments, the data loss prevention system 101 generates the random bytes 309 based on a stored parameter for a number N of bytes to replace in the file 104. In some embodiments, the data loss prevention system 101 generates the random bytes 309 using a pseudorandom number generator configured to generate an input number of random byte values (e.g., N number of random bytes values). In some embodiments, the pseudorandom number generator for generating the random bytes 309 includes a script or function that is executed or called by the data loss prevention system 101.

In some embodiments, the data flow 300 includes the data loss prevention system 101 determining locations of a random subset of bytes 313 in the file 104 to replace with the random bytes 309. In some embodiments, the data flow 300 includes the data loss prevention system generating a location array 311 that defines the location of each byte of the random subset of bytes 313 in the file 104 (e.g., location referring to byte offset, line and/or column index, or other suitable data for indicating an original position of each byte of the random set of bytes 303 in the file 104). In some embodiments, the data loss prevention system 101 determines the random subset of bytes 313 (e.g., identifies locations of bytes in the file 104 that will form the random subset of bytes 313) based on a random number N (e.g., a random integer, which may be generated randomly using a pseudorandom number generator, determined based on a file transfer policy 110, or determined based on the file percentage parameter 303. In some embodiments, based on the random number N, the data loss prevention system 101, identifies N number of random locations in the file 104, where the byte located at each random location will be replaced by one of the random bytes 309 and form part of the random subset of bytes 313.

In some embodiments, the data loss prevention system 101 generates a plurality of random locations (e.g., byte offsets or line and column indices) based on the number N and the size of the file 104. In some embodiments, the number N is a multiple of the minimum block size for a symmetric key that may be used to encrypt a data object including the random subset of bytes 313. For example, the number N may be a multiple of the minimum AES encryption block size. In some embodiments, to determine the locations of the random subset of bytes 313, the data loss prevention system 101 performs a random integer walk. For example, the data loss prevention system 101 may select a random integer between 0 and the size of the file 104. The data loss prevention system 101 may identity, for replacement, one AES block size (e.g., 128 bits) at the offset of the random integer in the file 104. The data loss prevention system 101 may select a new integer between 0 and the size of the file 104 and may confirm that the new integer does not overlap with locations in the file 104 that were identified based on previously selected integers. The data loss prevention system 101 may identify a new AES block size at the offset of the newly selected integer. The data loss prevention system 101 may loop through the above described operations until N number of bytes are identified (e.g., and replaced with one of the random bytes 309).

In some embodiments, the data flow 300 includes the data loss prevention system 101 generating a randomly modified file 304 by replacing the byte value at each randomly determined location of the file 104 with one of the random bytes 309. For example, as the data loss prevention system 101 identifies each byte location in the file 104 as described above, the data loss prevention system 101 may replace the original byte value at that location with a randomly generate byte value until N number of bytes in the file 104 are replaced, thereby generating the randomly modified file 304. The data loss prevention system 101 may generate the location array 311 including the location in the file 104/randomly modified file 304 corresponding to each replaced byte. In some embodiments, the data loss prevention system 101 encrypts the location array 311 using a first key 314, such as an AES encryption key or other suitable symmetric encryption key. In some embodiments, the data loss prevention system 101 generates the first key 314 in response to receiving the file transfer requests 301.

In some embodiments, the data flow 300 includes the data loss prevention system 101 determining the random subset of bytes 313 form the file 104 based on the randomly determined locations in the file 104. In some embodiments, the data flow 300 includes the data loss prevention system 101 generating a data object including the random subset of bytes 313 and encrypting the data object using the first key 314 to generate an encrypted data object 315. In some embodiments, symmetric keys used to encrypt the random subset of bytes 313 and the location array 311 are the same symmetric key or two different symmetric keys, each of which may be generated by the data loss prevention system 101.

In some embodiments, the data flow 300 includes the data loss prevention system 101 encrypting the first key 314 with a second key 316 to generate an encrypted first key 317. In some embodiments, the second key 316 is a public key of an asymmetric key pair. For example, the data loss prevention system 101 may encrypt an AES key (e.g., first key 314) with a public RSA key (e.g., second key 316) to generate an RSA-encrypted AES key (e.g., encrypted first key 317).

In some embodiments, the data flow 300 includes the data loss prevention system 101 generating a legend data object 319 that includes the location array 311, which may be encrypted using the first key 314, and optionally the encrypted data object 315 and the encrypted first key 317. In some embodiments, the data loss prevention system 101 encrypts the legend data object 319 using the second key 316. For example, the data loss prevention system 101 may encrypt the legend data object 319 using a public RSA key.

In some embodiments, the data flow 300 includes the data loss prevention system 101 providing the randomly modified file 304, the encrypted data object 315, the encrypted first key 317, and/or the legend data object 319 including the location array 311 to a file storage device 113 indicated in the file transfer request 301. In some embodiments, the data loss prevention system 101 transfers the randomly modified file 304 to the file storage device 113 and provides the encrypted data object 315, the encrypted first key 317, and/or the legend data object 319 to the computing device 111 from which the file transfer request was received (e.g., or otherwise on behalf of which the file 104 was partially encrypted). In some embodiments, the legend data object 319 is provided in an encrypted format (e.g., where encryption was performed using the second key 316). In some embodiments, the legend data object 319 includes the location array 311, which may be encrypted using the first key 314, the encrypted data object 315, and/or the encrypted first key 317.

In some embodiments, the data flow 300 includes the data loss prevention system 101 decrypting the randomly modified file 304 to restore the file 104. For example, the data loss prevention system 101 may decrypt the randomly modified file 304 using the encrypted data object 315, the encrypted first key 317, the legend data object 319, and the second key 316. In some embodiments, the data loss prevention system decrypts the legend data object (e.g., if encrypted) using the second key 316 (e.g., or a corresponding private key, where the second key 316 is a public key of an asymmetric key pair). In some embodiments, to provide user access to the second key 316, the data loss prevention system 101 performs a biometric verification operation to verify an identity of a user requesting decryption of the randomly modified file 304 (and/or who is associated with the computing device 111 and/or user account 108 that requests the decryption). In some embodiments, the data loss prevention system 101 obtains the encrypted first key 317, the encrypted data object 315 and the location array 311 (e.g., which may be encrypted using the first key 314) from the legend data object 319 following decryption using the second key 316.

In some embodiments, the data loss prevention system 101 decrypts the encrypted first key 317 using the second key 316 to recover the first key 314. In some embodiments, the data loss prevention system 101 uses the first key 314 to decrypt the encrypted data object 315 to access the random subset of bytes 313. In some embodiments, the data loss prevention system 101 uses the first key 314 to decrypt the location array 311. In some embodiments, using the random subset of bytes 313 and the location array 311, the data loss prevention system 101 restores the file 104 by replacing, in the randomly modified file 304, the random bytes 309 with corresponding original byte values at the original byte location in the file 104.

FIG. 4 illustrates an example data architecture 400 in accordance with at least some example embodiments of the present disclosure. Specifically, FIG. 4 illustrates a data architecture 400 for a portion of data included in or associated with encryption data, files of original format, randomly modified files, file transfer policies, and one or more user accounts in accordance with at least some embodiments of the present disclosure. In this regard, any encryption data, files of original format, randomly modified files, file transfer policies, and user accounts received, transmitted, generated, and/or otherwise manipulated via the systems described herein may be architected in accordance with the depicted data architecture to include the particular data values therein. The encryption data, file of original format, randomly modified file, file transfer policies, user account, and contents thereof, shown in FIG. 4 and described herein are exemplary in nature, non-exhaustive and are provided to illustrate and describe exemplary aspects of the present systems and processes according to various embodiments.

As illustrated, the encryption data 106 may include one or more location arrays 311, one or more encrypted data objects 315, one or more legend data objects 319, key data 401, and 402 metadata. In some embodiments the location array 311 defines a location of one or more bytes of a file 104 that are replaced with random data to generate a randomly modified file 304. For example, the location array 311 may define a location of the original value of each byte of a random subset of bytes in the file 104 that are replaced by random data to generate a randomly modified file 304. In some embodiments, the location array 311 includes data identifying a position of a byte in a file (e.g., a one- or multi-dimensional array of bytes), such as a byte offset or one or more index values that indicate a location of a byte within the file (e.g., a line index and/or column index). In some embodiments, the location array 311 is encrypted using a symmetric key, such as an advanced Encryption Standard (AES) key.

In some embodiments, the encrypted data object 315 includes, in encrypted form, original values of a random subset of bytes of a file 104. In various embodiments, the random subset of bytes in the file 104 include bytes that are replaced with random data during generation of the randomly modified file 304 from the file 104. In some embodiments, the encrypted data object 315 is encrypted using the same or a different symmetric key as the location array 311. In some embodiments, the legend data object 319 includes the encrypted data object 315. In other embodiments, the encrypted data object 315 is not included in (e.g., is external to) the legend data object 319.

In some embodiments, the legend data object 319 includes data that indicates an original location and/or original value of a random subset of bytes in a file 104 (e.g., which are replaced with random data to generate a randomly modified file 304). In some embodiments, the legend data object 319 includes a location array 311, which may be unencrypted or encrypted using a symmetric key, such as an AES key. In some embodiments, the legend data object 319 includes an encrypted data object 315, where the encrypted data object 315 is encrypted using a symmetric key (e.g., which may be the same or a different symmetric key used to encrypt a corresponding location array 311). In some embodiments, the legend data object 319 includes key data 401, such as one or more encrypted symmetric keys (e.g., also referred to herein as a “first key”) by which a location array 311 or a data object including original values of a random subset of bytes from the file 104 are encrypted. In some embodiments, the legend data object 319 is encrypted using an asymmetric key, such as a public key of an RSA key pair.

In some embodiments, the key data 401 includes one or more symmetric keys for encrypting and decrypting various data as described herein, such as location arrays 311 or data objects including random subsets of bytes from files 104. In one example, the symmetric key includes an AES encryption key. In some embodiments, the key data 401 includes data defining a length of the symmetric key, such as 128 bits, 192 bits, 256 bits, or other suitable key lengths. In some embodiments, the key data 401 includes data that defines one or more algorithms, models, or other techniques for generating a symmetric key, such as an AES algorithm, Data Encryption Standard (DES) algorithm, International Data Encryption Algorithm (IDEA), Blowfish algorithm, or Rivest cipher-based algorithm.

In some embodiments, the key data 401 includes one or more asymmetric keys, or key pairs, for encryption and decrypting various data as described herein, such as symmetric keys or legend data objects 319. In one example, the asymmetric key includes a Rivest, Shamir, and Adleman (RSA) public-private key pair. The public key may be used by the apparatus 200 to encrypt a symmetric key or legend data object 319 and a computing device 111 may be provisioned with a private key for decrypting an encrypted symmetric key or encrypted legend data object. In some embodiments, the key data 401 includes data that defines one or more algorithms, models, or other techniques for generating a symmetric key, such as an RSA algorithm, Diffie-Hellman key exchange algorithm, or Digital Signature Algorithm (DSA). In some embodiments, the apparatus 200 includes a public key of a key pair and a computing device 111, or user account 108, is provisioned with a private key of the key pair.

In some embodiments, the metadata 402 includes data associated with accessing and transferring files 104 and randomly modified files 304. In some embodiments, the metadata 402 includes a timestamp for generation of a file 104, a timestamp for receipt of a request to transfer the file 104, a timestamp for generation of a randomly modified file 304 from the file 104 in response to the transfer request, a timestamp for transfer of the randomly modified file 304 to a file storage device 113, a timestamp for a request to decrypt the randomly modified file 304, a timestamp for restoration of the file 104 from the randomly modified file 304 in response to a decryption request, and/or the like. In some embodiments, the metadata 402 includes a user identifier that identifies a user account 108 that requested transfer of a file 104 or decryption of a randomly modified file 304. In some embodiments, the metadata 402 includes authentication data for verifying user identity. For example, the metadata 402 may include hashes of user credentials (e.g., username, password, and/or the like), one or more biometric templates, one or more device identifiers (e.g., IP address, MAC address, IMEI number), and/or the like that may be compared against user inputs to verify user or device identity. In some embodiments, the metadata 402 includes data associated with generation of a randomly modified file 304. For example, the metadata 402 may include a file percentage parameter that was used to determine a random subset of bytes in a file 104 to replace with random data and which was used to determine a quantity of the random data. In some embodiments, the metadata 402 includes one or more identifiers that define associations between a randomly modified file, a location array 311, an encrypted data object 315, a legend data object 319, key data 401, a file 104, one or more file transfer policies 110, one or more user accounts 108, and/or the like.

In some embodiments, the file transfer policies 110 define rules for performing processes and operations described herein, such as rules by which files are partially encrypted to improve data loss prevention and/or reduce threats from malicious software or computing entities. In some embodiments, a file 104 is associated with one or more file transfer policies 110 such that the apparatus 200 and/or computing device 111 applies the file transfer policy 110 in response to requests to transfer or access the file 104 or decrypt a randomly modified file 304 (e.g., to restore a corresponding file 104). In some embodiments, a file transfer policy 110 defines a key length utilized for generating one or more encryption keys, such as a length of a symmetric key or an asymmetric key pair.

In some embodiments, a file transfer policy 110 defines a file percentage parameter for use in determining a quantity of random bytes in a file 104 to replace with random data. For example, a file transfer policy 110 may include a mandatory file percentage parameter of 10%, 15%, 30%, or 50% of the file, or any other suitable percentage. In some embodiments, a file transfer policy 110 defines an acceptable range within which a user or pseudorandom number generator may configure a file percentage parameter. For example, a file transfer policy may include a file percentage parameter range of 10-80%, 10-50%, 20-60%, or any other suitable percentage range. In some embodiments, a file transfer policy 110 defines a minimum value for a file percentage parameter (e.g., 5%, 10%, or any suitable value) and/or a maximum value for a file percentage parameter (e.g., 50%, 70%, 80%, or any other suitable value). In some embodiments, a file transfer policy 110 defines one or more conditions for configuring a file percentage parameter. For example, a file transfer policy 110 may define a first file percentage parameter (e.g., or range, minimum value, or maximum value) for use when a file 104 is within a first file size range (e.g., 0.01-1 gigabyte (GB), 1-10 GB, or any suitable range value), a second file percentage parameter for use when a file 104 is within a second file size range (e.g., 10-100 GB, 10-50 GB, another suitable range value), and a third file percentage parameter for use when a file 104 is within a third file size range (e.g., 100-500 GB, 100 GB-1 terabyte (TB), or another suitable range value). The first file percentage parameter may be 70%, the second file percentage parameter may be 50%, and the third file percentage parameter may be 30%. In some embodiments, by customizing file percentage parameter value (e.g., magnitude of partial encryption) based on file size, the present techniques for data loss prevention ensure file security while balancing time and computing resources required to perform encryption of large files, thereby improving computing efficiency and user experiences.

In some embodiments, a file transfer policy 110 defines different file percentage parameters for use in partially encrypting different file types. For example, the file transfer policy 110 defines a first file percentage parameter for use in partial encryption of software patch files, a second file percentage parameter for use in partial encryption of text, document, spreadsheet, or electronic mail files, and a third file percentage parameter for use in partial encryption of media files (e.g., audio files, image files, video files, and/or the like). In some embodiments, the file transfer policy 110 defines different file percentage parameters for different user accounts 108, which may be based on a clearance level of a user account 108, an age of a user account 108, a role or position of a user associated with a user account, and/or the like. For example, the file transfer policy 110 defines a first file percentage parameter for use in partially encrypting a file 104 in response to a request from a first user account 108 and a second file percentage parameter, greater than the first file percentage parameter, for use in partially encrypting the file 104 in response to a request from a second user account 108. The second user account 108 may be a newer account associated with a lower clearance level, trust level, employment status or other role, and/or the like.

In some embodiments, a file transfer policy 110 defines different file percentage parameters to be used based on a physical location associated with a file 104, a computing device 111, and/or a user. For example, the file transfer policy 110 defines a first file percentage parameter for use when a user, or computing device 111, is located in a first geozone (e.g., associated with a lower level of cybersecurity risk) and a second file percentage for use when the user is located in a second geozone (e.g., associated with a higher level of cybersecurity risk). In some embodiments, the file transfer policy 110 defines different file percentage parameters to be used based on a network 118 associated with a request to transfer or access the file 104. For example, the file transfer policy 110 may define a first file percentage parameter for use when a request is received via a local or internal network and define a second file percentage parameter for use when a request is received via an external or Internet network. In some embodiments, the file transfer policy 110 defines different file percentages to be used based on an identity of a file storage device 113. For example, the file transfer policy 110 may define a first file percentage parameter to be used when an apparatus 200 determines that a device identifier for a file storage device 113 appears in a listing of recognized file storage devices and may define a second file percentage parameter, greater than the first file percentage parameter, to be used when the apparatus 200 determines that a device identifier for a file storage device 113 does not appear in the listing of recognized file storage devices.

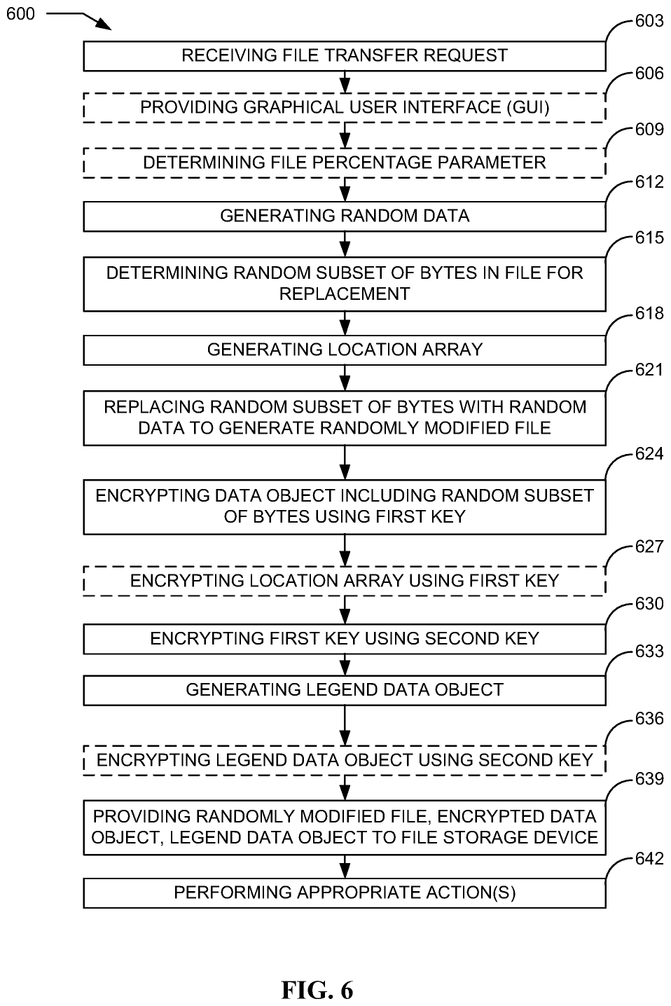

In some embodiments, a file transfer policy 110 defines conditions for performing partial encryption of a file 104. For example, the file transfer policy 110 may define one or more conditions in response to which the apparatus initiates the process 600, or a subset of operations thereof, shown in FIG. 6 and described herein. In some embodiments, the file transfer policy 110 configures the apparatus 200, or computing device 111, to perform partial encryption of a file 104 when the file 104 is created at or downloaded to the computing device 111. For example, the file transfer policy 110 may cause the apparatus 200 to perform partial encryption of a file 104 in response to detecting or receiving an indication that a computing device 111 downloaded the file 104, created the file 104, performed a save action respective to the file 104, or exported the file 104 to a secondary file 104 of the same or different file type. In some embodiments, the present techniques for performing partial encryption of created/downloaded files in substantially real-time may improve security of computing systems such that a malicious entity is substantially delayed or prevented from accessing the protected data. For example, the present techniques for partial encryption may improve data loss prevention by securing files before full disk encryption initiates. In a scenario where an attacker offloads data from a hard drive before initiation of full disk encryption, the partial encryption of the stolen data may substantially delay or prevent the attacker from accessing or using the data, thereby reducing or preventing data loss impact by increasing available time for engaging law enforcement, updating passwords and other credentials, informing users, and/or the like.

In some embodiments, a file transfer policy 110 defines when the apparatus 200 performs partial encryption of a file 104. For example, the file transfer policy 110 may define a time variable based upon which the apparatus 200 queries the computing device 111 to identify and partially encrypt any newly created or downloaded files 104. The time variable may cause the apparatus 200 to perform such operations hourly, daily, weekly, or at any suitable frequency. In another example, the file transfer policy 110 causes the apparatus 200 to partially encrypt newly created or downloaded files at the computing device 111 based on a workload schedule, such as a time that corresponds to an end of a scheduled shift for a user account 108 or user associated with the computing device 111.

In some embodiments, a file transfer policy 110 defines one or more verification operations that are enforced by the apparatus 200 in response to a request to transfer a file 104. For example, the file transfer policy 110 may cause the apparatus 200 to perform a biometric verification operation to provide user access to one or more keys used in partial encryption of a file 104. As another example, the file transfer policy may cause the apparatus 200 to enforce a multi-factor authentication challenge to provide user access to one or more keys (e.g., the dual factor authentication including receiving and verifying multiple user- or device-identifying elements, such as user credentials, user biometric data, device data, and/or the like). In some embodiments, biometric data includes captures, scans, or other data constructs that define a user's fingerprint, palm print, retina, facial features, facial geometry, voice, subdermal anatomical features, and/or the like. In some embodiments, a biometric template includes biometric data verified as being associated with a user, such as via a biometric enrollment operation.

In some embodiments, the file transfer policy 110 defines one or more conditions for decrypting a randomly modified file 304 (e.g., to restore a file 104). For example, the file transfer policy 110 may cause the apparatus 200 to enforce a biometric verification operation to provide user access to one or more keys required for decryption of a randomly modified file 304. In another example, the file transfer policy 110 causes the apparatus 200 to enforce a multi-factor authentication challenge to provide user access to one or more keys. In another example, the file transfer policy 110 causes the apparatus 200 to restrict decryption services for a computing device 111, user account 108, and/or user based on a threshold time interval, a threshold number of randomly modified files 304 (e.g., potentially within a threshold time interval), a threshold amount of data (e.g., based on a file size of randomly modified files 304 for which decryption is requested), and/or the like. In another example, the file transfer policy 110 causes the apparatus 200 to restrict decryption services for the computing device 111 based on a physical location of the requesting computing device 111 as compared to one or more predetermined locations at which decryption is permitted (e.g., for any randomly modified file 304 or a particular randomly modified file 304 associated with a decryption request). In still another example, the file transfer policy 110 causes the apparatus 200 to restrict decryption services for the computing device 111 based on a network location of the requesting computing device 111 as compared to one or more predetermined networks 118 within which decryption is permitted.

In some embodiments, the user account 108 includes associations between one or more data shown in the data architecture 400 and described herein. For example, the user account 108 may include associations between the user account 108, one or more files 104, and one or more randomly modified files 304. In another example, the user account 108 may include associations between the user account 108 and one or more file transfer policies 110 such that the apparatus 200 applies the file transfer policy 110 when responding to partial encryption or decryption requests associated with the user account 108 or a corresponding computing device 111. In some embodiments, a computing device 111 of a user account 108 is provisioned with one or more file transfer policies 110 such that requests from the computing device 111 to the apparatus 200 include the one or more file transfer policies 110 or identifiers by which the one or more file transfer policies may be determined by the apparatus 200.

FIG. 5 illustrates a diagram of an example workflow 500 for data loss prevention using partial encryption in accordance with at least some example embodiments of the present disclosure. In some embodiments, the workflow 500 depicts example intermediary and final outputs of partial encryption techniques for data loss prevention described herein and further illustrated in FIGS. 3 and 6. In various embodiments, the data loss prevention system 101 performs the workflow 500, such as via the encryption apparatus 200, in response to receiving a request to transfer file a 104 from a computing device, in response to detecting download of the file 104 to the computing device, in response to detecting creation of the file 104 at the computing device, or in response to detecting modification of the file 104 at the computing device.

In some embodiments, the workflow 500 includes the data loss prevention system 101 obtaining the file 104, which may correspond to an original, unencrypted version of a file. In some embodiments, the workflow 500 includes the data loss prevention system 101 performing a partial encryption sequence 502 to replace N number of randomly selected bytes in the file 104 with randomly generated byte values. In some embodiments, the data loss prevention system performs steps of the partial encryption sequence 502 in a loop until the N number of random original bytes in the file 104 are replaced with randomly generated byte values, thus generating, as output, a randomly modified file 304.

In some embodiments, the data loss prevention system 101 selects a random integer value between 0 and a size of the file 104, which may be determined by the data loss prevention system 101 and include a total number of bytes of the file 104. In some embodiments, the data loss prevention system 101 determines a location in the file 104 based on the random integer. For example, the data loss prevention system may determine a byte offset within the file 104 based on the random integer. In some embodiments, the data loss prevention system 101 generates N number of random byte values, where N may be a percentage of the size of the file 104, such as a percentage of the total number of bytes of the file 104. In some embodiments, the data loss prevention system 101 replaces one or more bytes at the determined location in the file 104. For example, the data loss prevention system 101 may replace one AES block size (e.g., 128 bits or 16 bytes) at the byte offset in the file 104 corresponding to the random integer.

In some embodiments, the data loss prevention system 101 selects (e.g., generates) a new random integer value between 0 and the size of the file 104. In some embodiments, the data loss prevention system 101 determines whether a byte offset based on the new random integer value results in an overlap with the byte offset of the previous random integer value. In some embodiments, the data loss prevention system 101 discards and reselects new random integer value until a new random integer value is selected that does not result in an overlap. In some embodiments, the data loss prevention system 101 replaces one or more bytes at a new location in the file 104 based on the newly selected random integer. In various embodiments, the data loss prevention repeats the above-described operations until N number of bytes in the file 104 are replace with random byte values such that the file 104 is converted to randomly modified file 304.

In some embodiments, based on the partial encryption sequence 502, the data loss prevention system 101 generates a location array 311 indicative of the determined locations of the original byte values and an encrypted data object 315 including the original byte values. In some embodiments, the data loss prevention system 101 generates a legend data object including the location array 311, the encrypted data object 315, and an encrypted first key 317, where the encrypted first key 317 is generated by encrypting the key used to generate the encrypted data object 315 with a second key. In some embodiments, the data loss prevention system 101 provides the randomly modified file 304 and legend data 503 including the legend data object 319 to a file storage device and/or a computing device that requested partial encryption of, downloaded, created, saved, or modified the file 104.

### Example Processes of the Disclosure

Having described example systems and apparatuses, data architectures, data flows, and graphical representations in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

FIG. 6 illustrates a flowchart depicting operations of an example process for data loss prevention using partial encryption in accordance with at least some example embodiments of the present disclosure. Specifically, FIG. 6 depicts operations of an example process 600. In some embodiments, the process 600 is embodied by computer program code stored on a non-transitory computer-readable storage medium of a computer program product configured for execution to perform the process as depicted and described. Additionally, or alternatively, in some embodiments, the process 600 is performed by one or more specially configured computing devices, such as the encryption apparatus 200 (“apparatus 200”) alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, one or more computing devices, and/or one or more file storage devices. For purposes of simplifying the description, the process 600 is described as performed by and from the perspective of the apparatus 200. In some embodiments, the apparatus 200 initiates the process 600 as a checkout procedure enforced upon a computing device 111 in response to the apparatus 200 receiving a request to transfer a file from (or on behalf of the computing device 111) to a file store device 113, or in response to the apparatus 200 determining that the computing device 111 downloaded, created, saved, or modified a file. For example, the apparatus 200 may automatically initiate the process 600 to enforce a checkout procedure for improving data loss prevention when a user of the computing device 111 attempts to remove a file from the computing device 111 to another device, such as a file storage device 113 or an additional computing device 111.

In some embodiments, the process 600 begins at operation 603. At operation 603, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that receive a request to transfer a file from a computing device 111 to a file storage device. For example, the apparatus 200 may receive the request to transfer the file from a computing device 111 to a file storage device 113. In some embodiments, the request includes data that identifies a file storage device 113 or other destination for the requested file transfer, such as another computing device 111. In some embodiments, the request indicates a file for which transfer is requested, such as via a filename or other identifier. In some embodiments, in response to the request, the apparatus 200 receives or retrieves one or more file transfer policies based on the computing device 111 associated with the request, a user account associated with the request, a network by which the request was received, the file storage device 113 associated with the request, and/or the file associated with the request. In some embodiments, the requested file is associated with one or more additional files, such as metadata files or resource files, which may also be partially encrypted or transferred to the file storage device 113 in original form.

In some embodiments, in response to receiving the request, the apparatus 200 generates metadata associated with accessing and transferring the file. In some embodiments, the metadata includes a timestamp for generation, saving, download, or modification of the file, a timestamp for receipt of the request to transfer the file, a physical location of the computing device 111 (e.g., which may be determined by the apparatus 200 via geolocation data obtained from the computing device 111). In some embodiments, the metadata includes a user identifier that identifies a user account 108 that requested transfer of a file. In some embodiments, the file transfer request includes a user input indicative of a file percentage parameter for configuring partial encryption of the file.

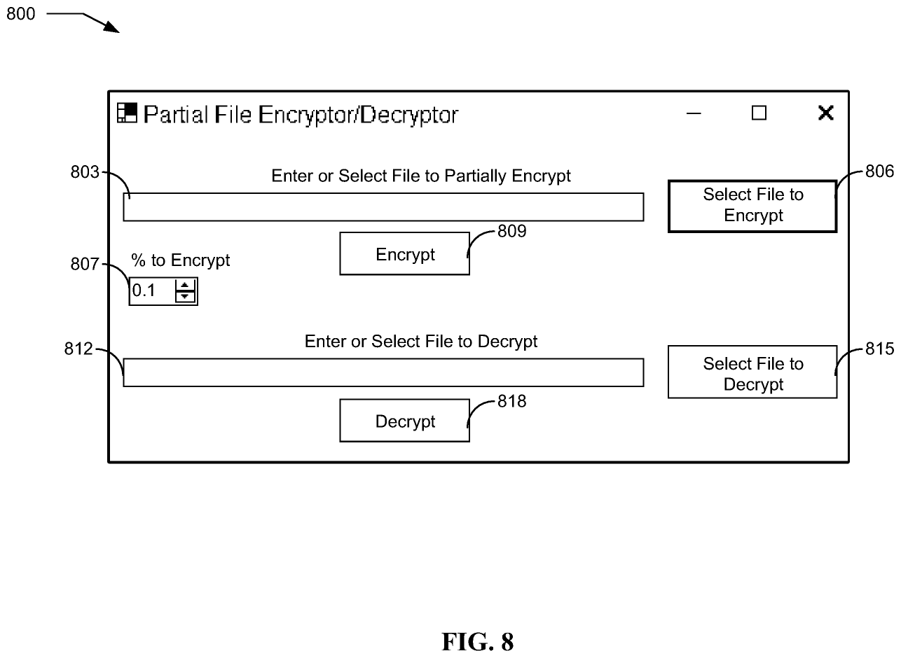

At operation 606, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that optionally provide a graphical user interface (GUI) for configuring partial encryption of the file. For example, the apparatus 200 may provide a graphical user interface (GUI) for configuring partial encryption of the file to the computing device 111. In some embodiments, in response to receiving the file transfer request from the computing device 111, the apparatus 200 provides a GUI to the computing device 111 for rendering on the display 114. In some embodiments, the GUI includes a user input field for receiving a user input indicative of the file and/or a selectable field for launching a file explorer or other application from which the file may be selected via user input and automatically indicated to the apparatus 200. In one example, the GUI may be the GUI 800 shown in FIG. 8 and described herein.

At operation 609, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that optionally generate a file percentage parameter for partially encrypting the file. For example, the apparatus 200 optionally determines a file percentage parameter for partially encrypting the file. In some embodiments, the file percentage parameter is a percentage of the file to be encrypted (e.g., via replacement of bytes in the file with random data). In some embodiments, the apparatus 200 determines the file percentage parameter based on a user input, a pseudorandom number generator, and/or one or more file transfer policies. In one example, the apparatus 200 may determine a minimum value, range, or maximum value of the file percentage parameter based on a file transfer policy. The apparatus 200 may update a GUI to indicate the minimum value, range, or maximum value. The apparatus 200 may receive a user input to the GUI that indicates the file percentage parameter. In some embodiments, the apparatus 200 applies a file transfer policy to the user input for the file percentage parameter to determine whether the inputted value is allowable. The apparatus 200 may reject the requested value and provide a notification to the computing device 111 in response to determining that the requested value for the file percentage parameter violates a file transfer policy.

In some embodiments, the apparatus 200 automatically configures the file percentage parameter based on one or more file transfer policies, such as where there file transfer policy indicates an explicit value and/or one or more conditions by which the apparatus 200 may determine the value (e.g., file type conditions, user account-based conditions, computing device-based conditions, and/or the like). In some embodiments, the apparatus 200 generates the file percentage parameter using a pseudorandom number generator that outputs a percentage value. The apparatus 200 may constrain the pseudorandom number generator based on a file transfer policy, such as by limiting output of the pseudorandom number generator to a range of acceptable values.

At operation 612, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that generate random data (e.g., a number N of random bytes). For example, the apparatus 200 may generate random data including a number N of random bytes. In some embodiments, the apparatus 200 determines N based on a user input, a file transfer policy, a pseudonumber generator, and/or the like. In some embodiments, the apparatus 200 determines N based on a file percentage parameter optionally generated at operation 609 and a size of the file. For example, the apparatus 200 may multiple the number of bytes in the file by the file percentage parameter to generate an integer output for N (e.g., potentially performing rounding operations to an output of the multiplication).

At operation 615, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that determine a random subset of bytes in the file (e.g., to be replaced using the random bytes of operation 612). For example, the apparatus 200 determines a random subset of bytes in the file based on the number N. In some embodiments, for a number of repetitions N, the apparatus 200 generates a random integer between 0 and the size of the file and determines the location of one or more bytes for inclusion in the random subset of bytes based on a location in the file corresponding to the random integer (e.g., a byte offset, line and/or column index, and/or the like). The apparatus 200 may repeat the generation of random integers and location identification until N number of byte locations in the file are determined. In some embodiments, the apparatus generates a different random integer in response to determining an overlap in byte locations based on a previously generated random integer.

In some embodiments, the apparatus 200 generates a data object including the original value of each byte of the random subset of bytes in the file. For example, at each determined location in the file, the apparatus 200 may update the data object to include a value of one or more bytes associated with the location. The value may be the value an individual byte value or a set of byte values respective to the location and corresponding to a block size for a symmetric encryption key that will be used to encrypt the data object including the random subset of bytes.

At operation 618, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that generate a location array. For example, the apparatus 200 generates the location array. In some embodiments, the location array defines a location in the file of each byte of the random subset of bytes in the file. The location array may include byte offsets, line and column indices, or other suitable information that defines locations of the original value of the bytes to be replaced in the file.

At operation 621, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that replace the random subset of bytes in the file with the random data of operation 612 to generate a randomly modified file. For example, the apparatus 200 generates a randomly modified file by replacing the random subset of bytes in the file with the random data of operation 612. It will be understood and appreciated that operations 612-621 may be performed as a looping sequence for a number of repetitions N and the apparatus 200 may update the data object and location array with one or more original byte values and byte locations during each performance of the sequence.

At operation 624, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that encrypt, using a first key, the data object including the original value of each byte in the random subset of bytes in the file. For example, the apparatus 200 may encrypt the data object of original byte values of the random subset using a first key. In some embodiments, an output of operation 624 includes an encrypted data object (e.g., including encrypted original values of the random subset of bytes in the file). In some embodiments, the first key is a symmetric encryption key, such as an AES encryption key.

At operation 627, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that optionally encrypt the location array using the first key. For example, the apparatus 200 may encrypt the location array using the first key reference in operation 624 or a different symmetric encryption key.

At operation 630, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that encrypt the first key using a second key. For example, the apparatus 200 may encrypt the first key using a second key. In some embodiments, the second key is a key from an asymmetric key pair. For example, the second key is a public key of an RSA key pair. In some embodiments, where the location array and the encrypted data object including the random subset of original byte values are encrypted using different symmetric encryption keys, the apparatus 200 encrypts each symmetric encryption key using the same or a different asymmetric encryption key.

In some embodiments, the apparatus 200 provides user access to the second key, which may include provisioning the computing device 111 with the second key or a paired encryption key (e.g., such as a private key corresponding to a public key used to encrypt the first key). In some embodiments, the apparatus 200 provides user access to the second key based on performing a biometric verification operation. For example, the apparatus 200 may prompt the computing device 111 to perform a biometric verification operation including obtaining a user's biometric data (e.g., fingerprint scan, facial scan, voice recording, iris capture, etc.,), optionally hashing the user's biometric data, and comparing the user's biometric data, or hashed biometric data, to one or more biometric templates (e.g., via a one-to-many comparison for biometric-based identification or a one-to-one comparison for biometric-based verification). In some embodiments, the user's biometric template is stored in and obtained from memory 117 of the computing device 111. In other embodiments, the apparatus 200 provides the user's biometric template to the computing device 111. The apparatus 200 may obtain the biometric template from a user account 108 stored at the data store 102. In some embodiments, the apparatus 200 receives the user's biometric data, or hashed biometric data, and compares the user's biometric data to a plurality of stored biometric data records (e.g., each corresponding to a different user). The comparison performed by the computing device 111 or apparatus 200 may include generating a similarity score between the user's biometric data and each biometric template (e.g., cosine similarity, L2 norm metric, squared Euclidean distance, and/or the like), determining the similarity score meets a predetermined minimum similarity threshold, and optionally determining a top-ranked biometric template based on a ranking of biometric templates by similarity score. In some embodiments, in response to the computing device 111 or the apparatus 200 verifying the user's identity based on the biometric verification operation, the apparatus 200 provides user access to the second key such that the second key may be used to decrypt the first key and other data encrypted using the second key.

At operation 633, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that generate a legend data object. For example, the apparatus 200 may generate the legend data object. In some embodiments, the legend data object includes the location array of operation 618 (or encrypted location array of optional operation 627). In some embodiments, the legend data object includes the encrypted data object of operation 624. In some embodiments, the legend data object includes the encrypted first key of operation 630.

At operation 636, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that optionally encrypt the legend data object using the second key. For example, the apparatus 200 may optionally encrypt the legend data object using the second key that was used to encrypt the first key at operation 630.

At operation 639, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that provide the randomly modified file, encrypted data object, encrypted first key, and legend data object (e.g., including the location array or encrypted location array) to a file storage device. For example, the apparatus 200 may provide the randomly modified file, encrypted data object, encrypted first key, and legend data object to the file storage device. In some embodiments, the legend data object also includes the encrypted data object and/or the encrypted first key.

At operation 642, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that perform one or more appropriate actions. For example, the apparatus 200 may perform one or more appropriate actions including generating and providing notifications, storing the randomly modified file and/or related data (e.g., legend data object, encrypted data object, and/or encrypted first key), performing a decryption process to restore the file using the randomly modified file and other encryption data. In some embodiments, the apparatus 200 generates and provides to the transfer-requesting computing device 111 a notification that indicates the availability of the randomly modified file. Additionally, or alternatively, in some embodiments, the apparatus 200 provides such a notification to a second computing device 111 associated with the file storage device 113, such as in an instance where the file storage device is embodied by memory 117 of a second computing device 111.

In some embodiments, the apparatus 200 updates metadata to indicate the partial encryption and transfer of the original file. The metadata may be stored at the data store 102, such as in association with a user account 108 corresponding to the requesting computing device 111. Additionally, or alternatively, the metadata may be stored in memory 117 of the requesting computing device 111, at the file storage device 113, and/or in memory 117 of a second computing device 111 (e.g., a computing device 111 configured to access the randomly modified file from the file storage device 113). For example, the apparatus 200 may modify the metadata to update a time series of check-ins and checkouts of the file and indicate the providing of the randomly modified file to the file storage device 113 (e.g., a new checkout of the file). The apparatus 200 may generate and store a new entry to the time series that includes data identifying the file, the computing device 111, the user account 108 associated with the computing device 111, and/or other metadata, such as a timestamp of the request received at operation 703, geolocation data that indicates a location of the computing device 111, and/or network information that identifies a network 118 by which the computing device 111 provided the request of operation 603.

In some embodiments, the apparatus 200 generates a file transfer report that indicates various information related to partial encryption of the file, including a filename, a file size, a file type, a file creation timestamp, a file modification timestamp, a partial encryption timestamp, a file transfer timestamp, an identifier for the requesting computing device 111, a physical location of the requesting computing device 111, a network location of the requesting computing device 111, an identifier for a user account associated with the requesting computing device 111 (and/or a second computing device associated with the file transfer device 113), an identifier for the file transfer device 113, a file percentage parameter utilized in partial encryption of the file, and/or the like. In some embodiments, the apparatus 200 updates a registry or other data construct at the data store 102 configured for tracking checkout procedures for files.

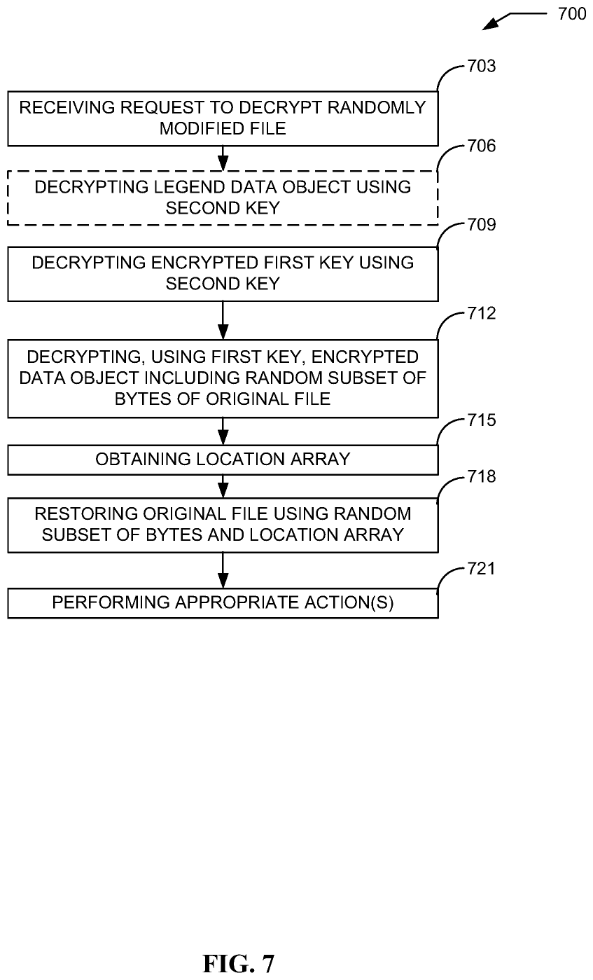

FIG. 7 illustrates a flowchart depicting operations of an example process for decryption accordance with at least some example embodiments of the present disclosure. Specifically, FIG. 7 depicts operations of an example process 700. In some embodiments, the process 700 is embodied by computer program code stored on a non-transitory computer-readable storage medium of a computer program product configured for execution to perform the process as depicted and described. Additionally, or alternatively, in some embodiments, the process 700 is performed by one or more specially configured computing devices, such as the encryption apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, one or more computing devices, and/or one or more file storage devices. For purposes of simplifying the description, the process 700 is described as performed by and from the perspective of the apparatus 200. In some embodiments, the apparatus 200 initiates the process 700 as a checkout procedure enforced upon a computing device 111 in response to the apparatus 200 receiving a request to decrypt a randomly modified file to restore a corresponding original file. For example, the apparatus 200 may automatically initiate the process 600 to as a subprocess of a checkout procedure for improving data loss prevention when a user of the computing device 111 attempts to access a randomly modified file from a file storage device 113.

At operation 703, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that receive a request to decrypt a randomly modified file.

In some embodiments, the request includes or indicates a storage location for the randomly modified filed, a legend data object, an encrypted data object including the original value of each byte of a file that was replaced to generate the randomly modified file, a location array defining a location of each byte in the original file from which the randomly modified file was generated, and an encrypted key. In some embodiments, the request includes a legend data object that includes the encrypted data object, the location array, and/or the encrypted key. In some embodiments, the legend data object is encrypted with a second key, which may be a key of a public-private key pair (e.g., an RSA key and/or the like).

In some embodiments, the apparatus 200 receives the request from a computing device 111. For example, the apparatus 200 may initiate the process 600 in response to a request from a first computing device 111 to generate the randomly modified file by partially encrypting an original file. The apparatus 200 may transfer the randomly modified file to a file storage device 113 based on the request from the first computing device (or provide the randomly modified file to the first computing device 111, which transfers the randomly modified file to the file storage device 113). A second computing device 111 may automatically, or in response to user input, access the randomly modified file on the file storage device 113, which may cause the apparatus 200 to automatically receive the request to decrypt the randomly modified file. Alternatively, the apparatus 200 may receive the request to decrypt the randomly modified file in response to the second computing device 111 receiving one or more user inputs, such as via a graphical user interface (GUI). For example, the apparatus 200 may receive the request in response to the second computing device 111 receiving one or more user inputs to the GUI 800 shown in FIG. 8 and described herein.

At operation 706, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that optionally decrypts the legend data object (e.g., in instances where the legend data object is encrypted using a key of a public-private key pair, also referred to herein as a second key). For example, the apparatus 200 may optionally decrypt the legend data object using a second key, which may be a private RSA key or other private key that is provisioned to the computing device 111 associated with the request to decrypt the randomly modified file. In some embodiments, by decrypting the legend data object using the second key, the apparatus 200 obtains a location array (e.g., which may be encrypted using a first key), an encrypted first key, and/or an encrypted data object.

In some embodiments, the apparatus 200 receives or accesses the second key from the computing device 111. In some embodiments, the apparatus 200 enforces a biometric verification operation to provide user access to the second key. For example, the apparatus 200 may prompt the computing device 111 to perform a biometric verification operation including obtaining a user's biometric data (e.g., fingerprint scan, facial scan, voice recording, iris capture, etc.,), optionally hashing the user's biometric data, and comparing the user's biometric data, or hashed biometric data, to one or more biometric templates (e.g., via a one-to-many comparison for biometric-based identification or a one-to-one comparison for biometric-based verification). In some embodiments, the user's biometric template is stored in and obtained from memory 117 of the computing device 111. In other embodiments, the apparatus 200 provides the user's biometric template to the computing device 111. The apparatus 200 may obtain the biometric template from a user account 108 stored at the data store 102. In some embodiments, the apparatus 200 receives the user's biometric data, or hashed biometric data, and compares the user's biometric data to a plurality of stored biometric data records (e.g., each corresponding to a different user). The comparison performed by the computing device 111 or apparatus 200 may include generating a similarity score between the user's biometric data and each biometric template (e.g., cosine similarity, L2 norm metric, squared Euclidean distance, and/or the like), determining the similarity score meets a predetermined minimum similarity threshold, and optionally determining a top-ranked biometric template based on a ranking of biometric templates by similarity score. In some embodiments, in response to the computing device 111 or the apparatus 200 verifying the user's identity based on the biometric verification operation, the apparatus 200 provides user access to the second key such that the second key may be used to decrypt an encrypted legend data object that includes the first key (e.g., a symmetric encryption key that was used to encrypt the encrypted data object and/or location array).

At operation 709, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that decrypt the encrypted first key using the second key (e.g., an asymmetric key, such as a private key of an RSA private-public key pair) to obtain the first key in unencrypted form. For example, the apparatus 200 may decrypt the encrypted first key using the second key. In some embodiments, the encrypted first key is a symmetric encryption key by which the encrypted data object and/or location array were encrypted during generation of the randomly modified file and which was encrypted using an asymmetric encryption key. For example, the encrypted first key may be an RSA-encrypted AES key. The second key may be the same asymmetric encryption key described in the preceding optional operation 706 or a different asymmetric key. In some embodiments, the apparatus 200 enforces a biometric verification operation to provide user access to the second key for decrypting the first key. The apparatus 200 may perform the biometric verification operation in similar manner to the above-described biometric verification operation of optional operation 706.

At operation 712, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that decrypt, using the first key (e.g., a symmetric encryption key), the encrypted data object that includes the random subset of bytes of the original file, which were replaced with random data to generate the randomly modified file. For example, the apparatus 200 may decrypt the encrypted data object using the first key (e.g., an AES key or other symmetric encryption key) to obtain the original values of the random subset of bytes of the original file.

At operation 715, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that obtain a location array. For example, the apparatus 200 may obtain the location array, which defines a location of each byte of the random subset of bytes of the original file such that corresponding locations in the randomly modified file may be identified. In some embodiments, the location array is an encrypted location array. For example, the request may include or indicate an encrypted location array, where the encrypted location array was encrypted using the first key (e.g., a symmetric encryption key). In another example, the legend data object may include an encrypted location array and the apparatus may retrieve the encrypted location array from the legend data object. In some embodiments, the encrypted location array is decrypted using the first key of operation 709 to obtain the location array. For example, the apparatus 200 may decrypt the encryption location array using an AES key that was also used to encrypt the data object containing the original value of each byte of the random subset of bytes of the original file.

At operation 718, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that restore the original file using the random subset of bytes obtained at operation 712 and the location array obtained at operation 715. For example, the apparatus 200 may restore the original file using the random subset of bytes and the location array. In some embodiments, restoring the original file includes replacing, based on the location array, a subset of bytes of the randomly modified file with corresponding original values of each byte of the random subset of bytes of the original file. For example, the apparatus 200 may identify a set of target bytes in the randomly modified file, where set of target bytes correspond to the random data with which the random subset of bytes was replaced during generation of the randomly modified file from the original file. The apparatus 200 may further use the location array to replace each byte of the set of target bytes with a corresponding original byte value from the random subset of bytes, thereby restoring the original file.

At operation 721, the apparatus 200 includes means such as the data intake circuitry 209, the data processing circuitry 211, the data analysis circuitry 213, the communications circuitry 205, the input/output circuitry 207, the processor 201, and/or the like, or a combination thereof, that perform one or more appropriate actions in response to restoring the original file. In some embodiments, the apparatus 200 causes the computing device 111 to load the restored original file. For example, in response to the apparatus 200 restoring the original file, the computing device 111 may automatically load the restored original file such that a user may access or observe the restored original file. In some embodiments, the apparatus 200 provides a notification to the computing device 111 that indicates the restoration of the original file. For example, the apparatus 200 may provide a notification to the computing device 111, which may be rendered on a display 114 to indicate to the user that the original file is now accessible. In some embodiments, the apparatus 200 updates metadata to indicate the restoration of the original file at and/or on behalf of the computing device 111 and/or a user account 108 associated with the computing device 111. For example, the apparatus 200 may identify, in metadata stored at the at a data store 102, a time series of check-ins and checkouts of the file. The apparatus 200 may generate and store a new entry to the time series that includes data identifying the file, the computing device 111, the user account 108 associated with the computing device 111, and/or metadata, such as a timestamp of the request received at operation 703, geolocation data that indicates a location of the computing device 111, and/or network information that identifies a network 118 by which the computing device 111 provided the request of operation 703. In some embodiments, the apparatus 200 prevents transfer of the restored file from the computing device 111 to the file storage device 113 from which the randomly modified file was obtained and/or an additional file storage device 113.

FIG. 8 shows an example graphical user interface (GUI) that includes user input fields for partial encryption and decryption, where at least some of the various named aspects of the GUI may be generated in accordance with the previously described and depicted figures. In some embodiments, the apparatus 200 provides the GUI 800 to a computing device 111. For example, the communications circuitry 205 and/or input/output circuitry 207 provides the GUI 800 to the computing device 111. The computing device 111 may render the GUI 800 on a display 114 and receive user inputs to the GUI 800 via one or more input devices 116. In some embodiments, the apparatus 200 provides the GUI 800 to the computing device 111 to enforce a checkout procedure for transferring a file from (or on behalf of) the computing device 111 to a file storage device 113 and/or decrypting a randomly modified file to restore the file.

In some embodiments, the GUI 800 includes a user input field 803 for receiving a user input that includes or indicates an identifier for one or more files to be partially encrypted. The identifier may include a filename, an identifier for the file in a file storage construct (e.g., folder, database, registry, and/or the like), a storage location for the file, such as a file explorer pathway, and/or the like. In some embodiments, the user input field 803 receives a drag and drop selection of a file from another GUI, such as a GUI associated with a file explorer application, and the user input field 803 is automatically populated with an identifier for the file. In some embodiments, the GUI 800 includes a selectable field 806 for launching a file explorer application, or accessing another file storage environment, to allow a user to select stored files for partial encryption. In some embodiments, the GUI 800 selectable field 809 for requesting or initiating partial encryption of the file. For example, in response to the selectable field 809 receiving a user input to the selectable field 809, the apparatus 200 may receive from the computing device 111 a request to partially encrypt the file indicated in the user input field 803. Following partial encryption to generate a randomly modified file based on the selected file, the computing device 111 may transfer the randomly modified file (e.g., and encryption data, such as an encrypted key, an encrypted data object including original values of a random replaced subset of bytes in the selected file, a legend data object including a location array, and/or the like) to a file storage device 113.

In some embodiments, the GUI 800 includes a user input field 807 for defining a file percentage parameter based upon which a file may be partially encrypted. In some embodiments, a user input to the user input field 807 includes a percentage, fractional, or decimal value based upon which the apparatus 200 determines a random subset of bytes in the file to replace with random data. For example, a user input to the user input field 807 may be 0.1, which the apparatus 200 may interpret as a file percentage parameter of 10% such that the apparatus 200 replaces, at random, 10% of bytes in the file with random data. In some embodiments, the GUI 800 limits a range of acceptable user inputs to the user input field 807 based on one or more file transfer policies. Such restriction of partial encryption may be performed to (i) ensure adequate security in the output randomly modified file by establishing a minimum percentage of bytes in the file to be replaced with random data and/or (ii) ensure computational efficiency and speed by establishing a maximum percentage of bytes in the file to be replaced with random data. For example, a file transfer policy may mandate that any partially decrypted file have at least 15% of original bytes replaced with random data (e.g., to increase difficulty of reversing or compromising the partial encryption), but no more than 50% of original bytes (e.g., to ensure efficient use of computing resources and avoid lengthy encryption operations).

In some embodiments, the GUI 800 includes a user input field 812 for receiving a user input that includes or indicates an identifier for a randomly modified file to be decrypted. The identifier may include a filename, an identifier for the randomly modified file in a file storage construct (e.g., folder, database, registry, and/or the like), a storage location for the randomly modified file, such as a file explorer pathway, and/or the like. In some embodiments, the user input field 812 receives a drag and drop selection of a randomly modified file from another GUI and the user input field 812 is automatically populated with an identifier for the file. In some embodiments, the user input field 812 also receives an identifier for one or more files that include encryption data by which a randomly modified file may be decrypted. For example, the user input field 812 receives an identifier for one or more folders that include a legend data object, a location array, an encrypted data object, and/or the like. In some embodiments, the GUI 800 includes a selectable field 815 for launching a file explorer application, or accessing another file storage environment, to allow a user to select randomly modified files for decryption, and potentially other data, such as encryption data for decrypting the randomly modified file. In some embodiments, the GUI 800 selectable field 818 for requesting or initiating decrypting of one or more randomly modified files. For example, in response to the selectable field 818 receiving a user input to the selectable field 818, the apparatus 200 may receive from the computing device 111 a request to decrypt the file indicated in the user input field 812 (e.g., or restore an original file indicated therein). Following decryption of the randomly modified file to restore a corresponding original file, the requesting computing device 111 may view, access, and/or otherwise interface with the original file.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving a request to transfer a file from a computing device to a file storage device;
determining a random subset of bytes in the file;
replacing the random subset of bytes in the file with random data to generate a randomly modified file;
generating a data object indicative of an original value of each byte of the random subset of bytes in the file;
encrypting the data object with a first key to generate an encrypted data object;
generating a legend data object comprising a location array defining a location of the original value of each byte of the random subset of bytes in the file;
encrypting the first key with a second key to generate an encrypted first key;
storing the encrypted first key and the encrypted data object in the legend data object; and
providing the randomly modified file and the legend data object to the file storage device.

2. The computer-implemented method of claim 1, wherein:
the computing device is a first computing device; and
the randomly modified file is configured to be decryptable, from the file storage device, at a second computing device during a checkout procedure based at least in part on the legend data object.

3. The computer-implemented method of claim 1, further comprising:
determining the random subset of bytes in the file based on a file percentage parameter.

4. The computer-implemented method of claim 3, further comprising:
determining the file percentage parameter based on a file transfer policy.

5. The computer-implemented method of claim 3, further comprising:
determining the file percentage parameter based on a pseudorandom number generator.

6. The computer-implemented method of claim 3, further comprising:
determining the file percentage parameter based on a user input.

7. The computer-implemented method of claim 6, further comprising:
applying a file transfer policy to the user input to generate the file percentage parameter.

8. The computer-implemented method of claim 6, further comprising:
in response to the request to transfer the file, providing a graphical user interface to the computing device, wherein the graphical user interface allows a user to provide the user input.

9. A computing apparatus comprising at least one processor and at least one non-transitory memory having computer-coded instructions stored thereon, the computer-coded instructions configured to, in execution with the at least one processor, cause the computing apparatus to:
receive a request to transfer a file from a computing device to a file storage device;
identify a random subset of bytes in the file;
replace the random subset of bytes in the file with random data to generate a randomly modified file;
generate a data object indicative of an original value of each byte of the random subset of bytes in the file;
encrypt the data object with a first key to generate an encrypted data object;
generate a legend data object comprising a location array defining a location of the original value of each byte of the random subset of bytes in the file;
encrypt the first key with a second key to generate an encrypted first key;
store the encrypted first key and the encrypted data object in the legend data object; and
provide the randomly modified file and the legend data object to the file storage device.

10. The computing apparatus of claim 9, wherein the computer-coded instructions, when executed by the at least one processor, further cause the computing apparatus to:
encrypt the legend data object using the second key prior to providing the legend data object to the file storage device.

11. The computing apparatus of claim 9, wherein the computer-coded instructions, when executed by the at least one processor, further cause the computing apparatus to:
encrypt the location array using the first key.

12. The computing apparatus of claim 9, wherein the computer-coded instructions, when executed by the at least one processor, further cause the computing apparatus to:
determine the random subset of bytes in the file based on a random integer walk.

13. The computing apparatus of claim 12, wherein the computer-coded instructions, when executed by the at least one processor, further cause the computing apparatus to:
initialize the random integer walk at a random location in the file, wherein the random location is determined based on at least one of a user input, a file transfer policy, or a pseudorandom number generator.

14. The computing apparatus of claim 9, wherein the computer-coded instructions, when executed by the at least one processor, further cause the computing apparatus to:
provide a graphical user interface to the computing device, wherein the graphical user interface allows a use to select a file for decryption using the second key.

15. The computing apparatus of claim 14, wherein the computer-coded instructions, when executed by the at least one processor, further cause the computing apparatus to:
at the computing device, provide user access to the second key based on a biometric verification operation.

16. A computer program product comprising at least one non-transitory, computer-readable storage medium including instructions that, upon execution by at least one processor, configure the computer program product to:
receive a request to transfer a file from a computing device to a file storage device;
identify a random subset of bytes in the file;
replace the random subset of bytes in the file with random data to generate a randomly modified file;
generate a data object indicative of an original value of each byte of the random subset of bytes in the file;
encrypt the data object with a first key to generate an encrypted data object;
generate a legend data object comprising a location array defining a location of the original value of each byte of the random subset of bytes in the file;
encrypt the first key with a second key to generate an encrypted first key;
store the encrypted first key in the legend data object; and
provide the randomly modified file and the legend data object to the file storage device.

17. The computer program product of claim 16, wherein:
the computing device is a first computing device; and
the randomly modified file is configured to be decryptable, from the file storage device, at a second computing device during a checkout procedure based at least in part on the legend data object.

18. The computer program product of claim 17, wherein the instructions, upon execution by the at least one processor, further configure the computer program product to:
perform a decryption operation comprising:
decrypting the first key using the second key;
decrypting the encrypted data object using the first key to obtain the random subset of bytes of the file;
obtaining the location array from the legend data object; and
restoring the file by replacing the random data of the randomly modified file with the random subset of bytes of the file based on the location array.

19. The computer program product of claim 18, wherein:
the decryption operation is performed by the second computing device as a subprocess of the file checkout procedure.

20. The computer program product of claim 18, wherein the instructions, upon execution by the at least one processor, further configure the computer program product to:
at the second computing device, provide user access to the second key based on a biometric verification operation.
